(19) United States
(12) Patent Application Publication
(10) Pub. No.: US 2022/0158179 A1
(43) Pub. Date: May 19, 2022

(54) METHODS OF FORMING AND USING ELECTROCHEMICAL CELLS COMPRISING A METAL SHEET

(71) Applicant: QuantumScape Battery, Inc., San Jose, CA (US)

(72) Inventors: Weston HERMANN, San Jose, CA (US); Jesse SHAPIRO, San Jose, CA (US); Joseph SALVI, San Jose, CA (US)

(21) Appl. No.: 17/433,559

(22) PCT Filed: Feb. 28, 2020
(86) PCT No.: PCT/US2020/020542

§ 371 Date: Aug. 24, 2021

Related U.S. Application Data
(60) Provisional application No. 62/812,155, filed on Feb. 28, 2019.

(51) Int. Cl. H01M 4/38; H01M 10/0562; H01M 10/0585

(52) U.S. Cl. CPC H01M 4/382; H01M 10/0585; H01M 10/0562

(57) ABSTRACT

Provided herein are electrochemical cells that include a metal sheet adjacent to a solid-state Li ion-conducting electrolyte in a manner that isolates a Li metal negative electrode from exposure to either, or both, a liquid electrolyte or a gel electrolyte used as a catholyte in the positive electrode. Some of the electrochemical cells include a series of electrochemical stacks, which may be stacked in a variety of configurations including configurations that share a Li metal negative electrode.

### CROSS-REFERENCE TO RELATED APPLICATIONS

This application claims priority to and the benefit of U.S. Provisional Patent Application No. 62/812,155, filed on Feb. 29, 2019, which is incorporated by reference herein in its entirety for all purposes.

### FIELD

The present disclosure sets forth solid-state lithium (Li) ion-conducting electrolytes and electrochemical cells including these electrolytes. The present disclosure concerns solid-state rechargeable batteries, which are also known as secondary batteries.

### BACKGROUND

As one strategy for maximizing the energy density in a rechargeable Li-ion battery, researchers try to incorporate Li-metal anodes. The voltage of a rechargeable Li-ion battery is determined by the potential difference for Li situated in the anode with respect to Li situated in the cathode. Since the voltage of Li in Li-metal is 0 V, the voltage of a rechargeable Li-ion battery is maximized when the anode is Li-metal. Because Li-metal is highly reactive, systems and methods for limiting the exposure of Li-metal to reactive species, e.g., organic solvents, are desired for rechargeable Li-ion batteries having Li-metal anodes.

New materials, methods, and uses of seals for protecting Li-metal anodes in rechargeable Li-ion batteries are needed. Set forth herein are solutions to this problem as well as other unmet needs in the relevant field to which the instant disclosure pertains.

### SUMMARY

In one embodiment, set forth herein is an electrochemical stack, in the discharged state, comprising a bilayer and a metal sheet: wherein the bilayer comprises a lithium-stuffed garnet film and a lithium-stuffed garnet-metal film; and wherein the metal sheet comprises a first metal layer and a second metal layer, wherein at least a portion of the bilayer is adjacent to the metal sheet.

In a second embodiment, set forth herein is an electrochemical stack, in the discharged state, comprising a bilayer and a metal sheet: wherein the bilayer comprises a lithium-stuffed garnet film and a lithium-stuffed garnet-metal film; and at least a portion of the bilayer is adjacent to the metal sheet.

In a third embodiment, set forth herein is an electrochemical stack comprising: a layer comprising lithium-stuffed garnet; a layer comprising a ceramic and a metal; and a metal sheet comprising a first portion and a second portion, wherein the metal sheet is adjacent to the layer comprising a ceramic and a metal.

In a fourth embodiment, set forth herein is an electrochemical stack comprising: a layer comprising lithium-stuffed garnet; a layer comprising a ceramic and a metal; and a metal sheet; wherein the layer comprising a ceramic and a metal is between and in contact with the layer comprising lithium-stuffed garnet and the metal sheet.

### BRIEF DESCRIPTIONS OF THE DRAWINGS

FIG. 1 shows a cross-sectional view of an embodiment of a not yet charged or a completely discharged electrochemical cell disclosed herein;

FIGS. 2A and 2B show cross-sectional views of an embodiment of a charged electrochemical cell disclosed herein;

FIG. 3 shows a cross-sectional view of an embodiment of a not yet charged or a completely discharged electrochemical cell disclosed herein;

FIG. 4 shows a top view of a bilayer of a portion of an embodiment of an electrochemical cell disclosed herein;

FIG. 5 shows a top view of a bilayer of a portion of an embodiment of an electrochemical cell disclosed herein,

FIG. 6 shows a cross-sectional view of an embodiment of a not yet charged or a completely discharged electrochemical cell disclosed herein;

FIG. 7 shows a cross-sectional view of an embodiment of a not yet charged or a completely discharged electrochemical cell disclosed herein; and

FIG. 8 shows a cross-sectional view of an embodiment of a not yet charged or a completely discharged electrochemical cell disclosed herein.

FIG. 9 shows a scanning electron microscope (SEM) cross-sectional image of the bilayer made in Example 1.

FIG. 10 shows a plot of capacity as a function of cycle number for the full cell prepared in Example 2.

### DETAILED DESCRIPTION

### I. GENERAL

The present disclosure sets forth solid-state lithium (Li) ion-conducting electrolytes and electrochemical cells including these electrolytes. The electrochemical cells include a metal sheet, or a seal, impermeable to a liquid electrolyte that is bonded to the solid-state Li ion-conducting electrolyte in a manner that effectively isolates and protects a Li metal negative electrode from exposure to either, or both, a liquid electrolyte or a gel electrolyte used as a catholyte in the positive electrode. In some examples, each stack includes a seal impermeable to a liquid electrolyte that is bonded to the solid-state Li ion-conducting electrolyte in a manner that effectively isolates and protects a Li metal negative electrode from exposure to either, or both, a liquid electrolyte or a gel electrolyte. In some examples, the metal sheet is bonded or sealed to the bilayer which comprises a lithium-stuffed garnet layer and a layer comprising a ceramic and a metal. During a charging cycle, when lithium plates between the lithium-stuffed garnet layer and a layer comprising a ceramic and a metal, the metal sheet bonded or sealed to the bilayer protects the lithium metal anode from exposure to ambient conditions or electrolyte solvents.

### II. DEFINITIONS

If a definition provided in any material incorporated by reference herein conflicts with a definition provided herein, the definition provided herein controls.

As used herein, the term “about,” when qualifying a number, e.g., about 15% w/w, refers to the number qualified and optionally the numbers included in a range about that qualified number that includes ±10% of the number. For example, about 15% w/w includes 15% w/w as well as 13.5% w/w, 14% w/w, 14.5% w/w, 15.5% w/w, 16% w/w, or 16.5% w/w. For example, “about 75° C.,” includes 75° C. as well 68° C., 69° C., 70° C., 71° C., 72° C., 73° C., 74° C., 75° C., 76° C., 77° C., 78° C., 79° C., 80° C., 81° C., 82° C., or 83° C.

As used herein, the phrase “at least one member selected from the group” and “selected from the group consisting of” includes a single member from the group, more than one member from the group, or a combination of members from the group. At least one member selected from the group consisting of A, B, and C includes, for example, A, only, B, only, or C, only, as well as A and B as well as A and C as well as B and C as well as A, B, and C or any combination of A, B, and C.

As used herein the phrase “active electrode material,” or “active material,” refers to a material that is suitable for use as a Li rechargeable battery and which undergoes a mostly reversible chemical reaction during the charging and discharging cycles. For examples, an “active cathode material,” includes, but is not limited to, a metal fluoride that converts to a metal and lithium fluoride during the discharge cycle of a Li rechargeable battery. In another example, “active cathode material,” includes, but is not limited to, a nickel manganese cobalt oxide (e.g., NMC-622 or NMC-811), a nickel aluminum cobalt oxide (e.g., NCA), a cobalt oxide (e.g., LiCoO₂), or an intercalation active material (NMC, LiFePO₄, NCA, V₂O₅).

As used herein, the phrase “active anode material” refers to an anode material that is suitable for use in a Li rechargeable battery that includes an active cathode material as defined above. In some examples, the active material is lithium metal. In some of the processes set forth herein, the sintering temperatures are high enough to melt the lithium metal used as the active anode material.

As used herein, the phrase “thickness” refers to the distance, or median measured distance, between the top and bottom faces of a layer in an electrochemical cell. As used herein, the top and bottom faces refer to the sides of the layer having the largest surface area.

As used herein, the term “electrolyte,” refers to an ionically conductive and electrically insulating material that allows ions, e.g., Li⁺, to migrate or conduct therethrough but which does not allow electrons to conduct therethrough. Electrolytes are useful for electrically insulating the positive and negative electrodes of a rechargeable battery while allowing for the conduction of ions, e.g., Li⁺, through the electrolyte. Electrolytes are useful for electrically isolating the cathode and anodes of a secondary battery while allowing ions, e.g., Lit, to transmit through the electrolyte. Solid electrolytes, in particular examples, rely on ion hopping through rigid structures. Solid electrolytes may be also referred to as fast ion conductors or super-ionic conductors. Solid electrolytes may be also used for electrically insulating the positive and negative electrodes of a cell while allowing for the conduction of ions, e.g., Lit, through the electrolyte. In this case, a solid electrolyte layer may be also referred to as a solid electrolyte separator or solid-state electrolyte separator.

As used herein, the phrase “solid-state separator” or “solid-state electrolyte” refers to a solid that conducts lithium ions with at least 10⁴ times higher conductivity than the solid conducts electrons. Li⁺ ion-conducting separators are solids at room temperature and include at least 50 vol % ceramic material. Examples include garnet, such as lithium-stuffed garnet, LBHI(N), LPSX, LiPON, and LiI. LBHI(N) is a composition including the elements Li—B—H, a halide (I, Br, Cl, and/or F) and optionally N. LPSX is a composition including the elements Li—P—S, and a halide (I, Br, Cl, and/or F), and that may contain other dopants. LiPON is a composition including the elements Li—P—O—N.

As used herein, the phrase “Li⁺ ion-conducting separator” refers to an electrolyte which conducts Li⁺ ions, is substantially insulating to electrons (e.g., the lithium ion conductivity is at least 10³ times, and often 10⁶ times, greater than the electron conductivity), and which acts as a physical barrier or spacer between the positive and negative electrodes in an electrochemical cell.

As used herein, the terms “cathode” and “anode” refer to the electrodes of a battery. The cathode and anode are often referred to in the relevant field as the positive electrode and negative electrode, respectively. During a charge cycle in a Li-secondary battery, Li ions leave the cathode and conduct through an electrolyte, to the anode. During a charge cycle, electrons leave the cathode and conduct through an external circuit to the anode. During a discharge cycle in a Li-secondary battery, Li ions conduct towards the cathode through an electrolyte and from the anode. During a discharge cycle, electrons leave the anode and conduct through an external circuit to the cathode.

As used herein, the phrase “positive electrode” refers to the electrode in a secondary battery towards which positive ions, e.g., Li⁺, conduct during discharge of the battery. As used herein, the phrase “negative electrode” refers to the electrode in a secondary battery from where positive ions, e.g., Li⁺, conduct during discharge of the battery. In a battery comprised of a Li-metal electrode and a conversion chemistry, intercalation chemistry, or combination conversion/intercalation chemistry-including electrode (i.e., cathode active material; e.g., NiFₓ, NCA, LiNiₓMn_{y}Co_{z}O₂ [NMC] or LiNiₓAl_{y}Co_{z}O₂ [NCA], wherein x+y+z=1), the electrode having the conversion chemistry, intercalation chemistry, or combination conversion/intercalation chemistry material is referred to as the positive electrode. In some common usages, cathode is used in place of positive electrode, and anode is used in place of negative electrode. When a Li-secondary battery is charged, Li ions move from the positive electrode (e.g., NiFₓ, NMC, NCA) towards the negative electrode (e.g., Li-metal). When a Li-secondary battery is discharged, Li ions move towards the positive electrode and from the negative electrode. When a Li-secondary battery is discharged, Li ions conduct towards the positive electrode (e.g., NiFₓ; i.e., cathode) and from the negative electrode (e.g., Li-metal; i.e., anode).

As used herein, the phrase “inorganic solid-state electrolyte” is used interchangeably with the phrase “solid separator” and refers to a material which does not include more than 10% by weight carbon and which conducts atomic ions (e.g., Li⁺) but does not conduct electrons. An inorganic solid-state electrolyte is a solid material suitable for electrically isolating the positive and negative electrodes of a lithium secondary battery while also providing a conduction pathway for lithium ions. Example inorganic solid-state electrolytes include oxide electrolytes and sulfide electrolytes, which are further defined below. Non-limiting example sulfide electrolytes are found, for example, in US Pat. No. 9,172,114, which issued Oct. 27, 2015, which are herein incorporated in its entirety for all purposes. Non-limiting examples of oxide electrolytes are found, for example, in U.S. Patent Application Publication No. 2015-0200420 A1, which published Jul. 16, 2015, which are herein incorporated in its entirety for all purposes. In some examples, the inorganic solid-state electrolyte also includes a polymer.

Examples solid-state electrolytes are found, for example, in International PCT Patent Application Nos. PCT/US2014/059575 and PCT/US2014/059578, GARNET MATERIALS FOR LI SECONDARY BATTERIES AND METHODS OF MAKING AND USING GARNET MATERIALS, filed Oct. 7, 2014, which published as WO 2015/054320 and WO 2015/076944, respectively, both of which are incorporated by reference herein in their entirety for all purposes.

As used herein, the term “catholyte” refers to a Li ion conductor that is intimately mixed with, or that surrounds and contacts, or that contacts the positive electrode active materials and provides an ionic pathway for Li⁺to and from the active materials. As used herein, the phrase “solid-state catholyte,” or the term “catholyte” refers to a solid electrolyte that is intimately mixed with, or surrounded by, a cathode (i.e., positive electrode) active material (e.g., a metal fluoride optionally including lithium). Solid-state catholytes suitable with the embodiments described herein include, but are not limited to, catholytes having the acronyms name LPS, LXPS, LXPSO, or LATS, where X is Si, Ge, Sn, As, or Al. LPS, LXPS, LXPSO, and LATS and further defined below. Also included herein as potential catholytes are borohydrides such as LiBH₄—LiX where X is F, Cl, Br, and/or I that may be optionally doped with compounds such as LiNH₂, or also lithium-stuffed garnets, or combinations thereof, and the like. Catholytes may also be liquid, gel, semi-liquid, semi-solid, polymer, and/or solid polymer ion conductors known in the art. In some examples, the catholyte includes a gel set forth herein. In some examples, the gel electrolyte includes any electrolyte set forth herein, including a nitrile, dinitrile, organic sulfur-including solvent, or combination thereof set forth herein. See for example the catholytes in U.S. Pat. No. 9,634,354 B2 or 9,553,332 B2, which are herein incorporated in their entirety for all purposes. See the gel electrolytes in WO2019213159A1, the published version of International PCT Patent Application No. PCT/US19/30038, which are herein incorporated in their entirety for all purposes.

In some examples, the electrolytes herein may include, or be layered with, or be laminated to, or contact a sulfide electrolyte. As used here, the phrase “sulfide electrolyte,” includes, but is not limited to, electrolytes referred to herein as LSS, LTS, LXPS, or LXPSO, where X is Si, Ge, Sn, As, Al, LATS. In these acronyms (LSS, LTS, LXPS, or LXPSO), S refers to the element S, Si, or combinations thereof, and T refers to the element Sn. “Sulfide electrolyte” may also include LiₐP_{b}S_{c}X_{d}, LiₐB_{b}S_{c}X_{d}, LiₐSn_{b}S_{c}X_{d} or LiₐSi_{b}S_{c}X_{d} where X═F, Cl, Br, I, and 10≤a≤50, 10≤b≤44, 24≤c≤70, 0≤d≤18 and may further include oxygen in small amounts. For example, oxygen may be present as a dopant or in an amount less than 10 percent by weight. For example, oxygen may be present as a dopant or in an amount less than 5 percent by weight. Sulfide electrolytes include inorganic materials containing S which conduct ions (e.g., Lit) and which are suitable for electrically insulating the positive and negative electrodes of an electrochemical cell (e.g., secondary battery). Exemplary sulfide based electrolytes include, but are not limited to, those electrolytes set forth in International PCT Patent Application No. PCT/US14/38283, SOLID STATE CATHOLYTE OR ELECTROLYTE FOR BATTERY USING Li_{A}MP_{B}S_{C} (M═SI, GE, AND/OR SN), filed May 15, 2014, and published as WO 2014/186634, on Nov. 20, 2014, which is incorporated by reference herein in its entirety; also, U.S. Pat. No. 8,697,292 to Kanno, et. al., the contents of which are incorporated by reference in their entirety.

As used herein, “LSS” refers to lithium silicon sulfide which can be described as Li₂S—SiS₂, Li—SiS₂, Li—S—Si, and/or a catholyte consisting essentially of Li, S, and Si. LSS refers to an electrolyte material characterized by the formula LiₓSi_{y}S_{z} where 0.33≤x≤0.5, 0.1≤y≤0.2, 0.4≤z≤0.55, and it may include up to 10 atomic % oxygen. LSS also refers to an electrolyte material comprising Li, Si, and S. In some examples, LSS is a mixture of Li₂S and SiS₂. In some examples, the ratio of Li₂S:SiS₂ is 90:10, 85:15, 80:20, 75:25, 70:30, 2:1, 65:35, 60:40, 55:45, or 50:50 molar ratio. LSS may be doped with compounds such as LiₓPO_{y}, LiₓBO_{y}, Li₄SiO₄, Li₃MO₄, Li₃MO₃, PSₓ, and/or lithium halides such as, but not limited to, LiI, LiCl, LiF, or LiBr, wherein 0≤x≤5 and 0≤y≤5.

As used herein, “LTS” refers to a lithium tin sulfide compound which can be described as Li₂S—SnS₂, Li₂S—SnS, Li—S—Sn, and/or a catholyte consisting essentially of Li, S, and Sn. The composition may be LiₓSn_{y}S_{z} where 0.25≤x≤0.65, 0.05≤y≤0.2, and 0.25≤z≤0.65. In some examples, LTS is a mixture of Li₂S and SnS₂ in the ratio of 80:20, 75:25, 70:30, 2:1, or 1:1 molar ratio. LTS may include up to 10 atomic % oxygen. LTS may be doped with Bi, Sb, As, P, B, Al, Ge, Ga, and/or In. As used herein, “LATS” refers to LTS, as used above, and further comprising Arsenic (As).

As used herein, “LXPS” refers to a material characterized by the formula LiₐMP_{b}S_{c}, where M is Si, Ge, Sn, and/or Al, and where 2≤a≤8, 0.5≤b≤2.5, 4≤c≤12. “LSPS” refers to an electrolyte material characterized by the formula LₐSiP_{b}S_{c}, where 2≤a ≤8, 0.5≤b ≤2.5, 4≤c ≤12. LSPS refers to an electrolyte material characterized by the formula LₐSiP_{b}S_{c}, wherein, where 2≤a≤8, 0.5≤b≤2.5, 4≤c≤12, d≤3. Exemplary LXPS materials are found, for example, in International Patent Application No. PCT/US14/38283, SOLID STATE CATHOLYTE OR ELECTROLYTE FOR BATTERY USING Li_{A}MP_{B}S_{C} (M=SI, GE, AND/OR SN), filed May 15, 2014, and published as WO 2014/186634, on Nov. 20, 2014, which is incorporated by reference herein in its entirety. Exemplary LXPS materials are found, for example, in US Patent Application Publication No. 2015/0171465, which is incorporated by reference herein in its entirety. When M is Sn and Si—both are present—the above LXPS material is referred to as LSTPS. As used herein, “LSTPSO” refers to LSTPS that is doped with, or has, O present. In some examples, “LSTPSO” is a LSTPS material with an oxygen content between 0.01 and 10 atomic %. “LSPS” refers to an electrolyte material having Li, Si, P, and S chemical constituents. As used herein “LSTPS” refers to an electrolyte material having Li, Si, P, Sn, and S chemical constituents. As used herein, “LSPSO” refers to LSPS that is doped with, or has, O present. In some examples, “LSPSO” is a LSPS material with an oxygen content between 0.01 and 10 atomic %. As used herein, “LATP,” refers to an electrolyte material having Li, As, Sn, and P chemical constituents. As used herein “LAGP” refers to an electrolyte material having Li, As, Ge, and P chemical constituents. As used herein, “LXPSO” refers to a catholyte material characterized by the formula LiₐMP_{b}S_{c}O_{d}, where M is Si, Ge, Sn, and/or Al, and where 2≤a≤8, 0.5≤b ≤2.5, 4≤c ≤12, d ≤3. LXPSO refers to LXPS, as defined above, and having oxygen doping at from 0.1 to about 10 atomic %. LPSO refers to LPS, as defined above, and having oxygen doping at from 0.1 to about 10 atomic %.

As used herein, “LPS” refers to an electrolyte having Li, P, and S chemical constituents. As used herein, “LPSO” refers to LPS that is doped with or has 0 present. In some examples, “LPSO” is a LPS material with an oxygen content between 0.01 and 10 atomic %. LPS refers to an electrolyte material that can be characterized by the formula LiₓP_{y}S_{z} where 0.33≤x≤0.67, 0.07≤y≤0.2 and 0.4≤z≤0.55. LPS also refers to an electrolyte characterized by a product formed from a mixture of Li₂S:P₂S₅ wherein the molar ratio is 10:1, 9:1, 8:1, 7:1, 6:1 5:1, 4:1, 3:1, 7:3, 2:1, or 1:1. LPS also refers to an electrolyte characterized by a product formed from a mixture of Li₂S:P₂S₅ wherein the reactant or precursor amount of Li₂S is 95 atomic % and P₂S₅ is 5 atomic %. LPS also refers to an electrolyte characterized by a product formed from a mixture of Li₂S:P₂S₅ wherein the reactant or precursor amount of Li₂S is 90 atomic % and P₂S₅ is 10 atomic %. LPS also refers to an electrolyte characterized by a product formed from a mixture of Li₂S:P₂S₅ wherein the reactant or precursor amount of Li₂S is 85 atomic % and P₂S₅ is 15 atomic %. LPS also refers to an electrolyte characterized by a product formed from a mixture of Li₂S:P₂S₅ wherein the reactant or precursor amount of Li₂S is 80 atomic % and P₂S₅ is 20 atomic %. LPS also refers to an electrolyte characterized by a product formed from a mixture of Li₂S:P₂S₅ wherein the reactant or precursor amount of Li₂S is 75 atomic % and P₂S₅ is 25 atomic %. LPS also refers to an electrolyte characterized by a product formed from a mixture of Li₂S:P₂S₅ wherein the reactant or precursor amount of Li₂S is 70 atomic % and P₂S₅ is 30 atomic %. LPS also refers to an electrolyte characterized by a product formed from a mixture of Li₂S:P₂S₅ wherein the reactant or precursor amount of Li₂S is 65 atomic % and P₂S₅ is 35 atomic %. LPS also refers to an electrolyte characterized by a product formed from a mixture of Li₂S:P₂S₅ wherein the reactant or precursor amount of Li₂S is 60 atomic % and P₂S₅ is 40 atomic %.

As used herein, the phrase “sulfide electrolyte” refers to a solid-state electrolyte that comprises lithium and sulfur. Particular sulfide electrolytes include Li₂S—P₂S₅, Li₂S—P₂S₅—SiS₂, Li₂S—P₂S₅—GeS₂, Li₂S—P₂S₅—SnS₂, Li₂S—P₂S₅—SnS₂—SiS₂, and Li₂S—GeS₂—Ga₂S₃. A sulfide electrolyte may be described as LiₐM_{b}M′_{c}M″_{d}SₑO_{f}Xᵢ where X is F, Cl, Br, and/or I, M, M′, and M″ are metal cations. Any sulfide electrolyte may further comprise oxygen, selenium or a halogen (F, Cl, Br, and/or I). Subscripts a, b, c, d, e, f, and i in the formula —LiₐM_{b}M′_{c}M″_{d}SₑO_{f}Xᵢ— are selected so the sulfide electrolyte is charge neutral.

As used herein, the phrase “current collector” refers to a component or layer in a secondary battery through which electrons conduct, to or from an electrode in order to complete an external circuit, and which are in direct contact with the electrode to or from which the electrons conduct. In some examples, the current collector is a metal (e.g., Al, Cu, or Ni, steel, alloys thereof, or combinations thereof) layer, which is laminated to a positive or negative electrode. During charging and discharging, electrons conduct in the opposite direction to the flow of Li ions and pass through the current collector when entering or exiting an electrode.

As used herein, the phrase “directly contacts” refers to the juxtaposition of two materials such that the two materials contact each other sufficiently to conduct either an ion or electron current between, or through, the two materials. As used herein, direct contact refers to two materials in contact with each other and which do not have any materials positioned between the two materials which are in direct contact.

As used herein, the phrases “electrochemical cell” or “battery cell” shall, unless specified to the contrary, mean a single cell including a positive electrode and a negative electrode, which have ionic communication between the two by way of an electrolyte. In some embodiments, a battery or module includes multiple positive electrodes and/or multiple negative electrodes enclosed in one container, e.g., a stack of electrochemical cells. A stack of electrochemical cells may be referred to as a multi-layered cell. A symmetric cell may be a cell having two Li metal anodes separated by a solid-state electrolyte.

As used herein, the phrase “electrochemical stack,” refers to one or more units which each include at least a negative electrode (e.g., Li, LiC₆), a positive electrode (e.g., Li-nickel-manganese-oxide or FeF₃, optionally combined with a solid-state electrolyte or a gel electrolyte and/or catholyte), and a solid electrolyte (e.g., lithium-stuffed garnet electrolyte set forth herein) between and in contact with the positive and negative electrodes. An electrochemical includes one or more units, which each include or share at least a negative electrode, a positive electrode, and a solid electrolyte between and in contact with the positive and negative electrodes. In some examples, between the solid electrolyte and the positive electrode, there is an additional layer comprising a gel electrolyte. An electrochemical stack may include one of these aforementioned units. An electrochemical stack may include several of these aforementioned units arranged in electrical communication (e.g., serial or parallel electrical connection). In some examples, when the electrochemical stack includes several units, the units are layered or laminated together in a column. In some examples, when the electrochemical stack includes several units, the units are layered or laminated together in an array. In some examples, when the electrochemical stack includes several units, the stacks are arranged such that one negative electrode is shared with two or more positive electrodes. Alternatively, in some examples, when the electrochemical stack includes several units, the stacks are arranged such that one positive electrode is shared with two or more negative electrodes. Unless specified otherwise, an electrochemical stack includes one positive electrode, one solid electrolyte, and one negative electrode, and optionally includes a gel electrolyte layer between the positive electrode and the solid electrolyte.

As used herein the phrase, “effectively isolates and protects a Li metal negative electrode from exposure to either, or both, a liquid electrolyte or a gel electrolyte,” refers to reducing the contact between a liquid and/or a gel electrolyte and lithium metal negative electrode below a threshold. The threshold is be defined as either when the lateral electronic conductivity of a lithium metal negative electrode reduces to less than 80% of its initial value or when the lithium metal negative electrode reduces to less than 80% of its initial capacity. Unless specified to the contrary, the threshold is defined as when the lateral electronic conductivity of a lithium metal negative electrode reduces to less than 80% of its initial value.

As used herein, the phrase “lithium-stuffed garnet” refers to oxides that are characterized by a crystal structure related to a lithium-stuffed garnet crystal structure. Lithium-stuffed garnets include compounds having the formula Li_{A}La_{B}M′_{c}M″_{D}Zr_{E}O_{F}, or Li_{A}La_{B}M′_{C}M″_{D}Nb_{E}O_{F}, wherein 4<A<8.5, 1.5<B<4, 0≤C≤2, 0≤D≤2; 0≤E<2.5, 10<F<13, and M′ and M″ are each, independently in each instance selected from Al, Mo, W, Nb, Ga, Sb, Ca, Ba, Sr, Ce, Hf, Rb, and Ta; or LiₐLa_{b}Zr_{c}Al_{d}M″ₑ″O_{f}, wherein 5<a<7.7; 2<b<4; 0<c≤2.5; 0≤d<2; 0≤e<2, 10<f<13 and Me″ is a metal selected from Nb, V, W, Mo, Ta, Ga, and Sb. Lithium-stuffed garnets, as used herein, also include those garnets described above that are doped with Al or Al₂O_{3.} Also, lithium-stuffed garnets as used herein include, but are not limited to, LiₓLa₃Zr₂O₁₂+yAl₂O₃. As used herein, lithium-stuffed garnet does not include YAG-garnets (i.e., yttrium aluminum garnets, or, e.g., Y₃Al₅O₁₂). As used herein, lithium-stuffed garnet does not include silicate-based garnets such as pyrope, almandine, spessartine, grossular, hessonite, or cinnamon-stone, tsavorite, uvarovite and andradite and the solid solutions pyrope-almandine-spessarite and uvarovite-grossular-andradite. Garnets herein do not include nesosilicates having the general formula X₃Y₂(SiO₄)₃ wherein X is Ca, Mg, Fe, and, or, Mn; and Y is Al, Fe, and, or, Cr.

As used herein, the phrase “lithium-stuffed garnet” refers to oxides that are characterized by a crystal structure related to a garnet crystal structure. U.S. Patent Application Publication No. U.S. 2015/0099190, which published Apr. 9, 2015 and was filed Oct. 7, 2014 as 14/509,029, is incorporated by reference herein in its entirety. This application describes Li-stuffed garnet solid-state electrolytes used in solid-state lithium rechargeable batteries. These Li-stuffed garnets generally having a composition according to Li_{A}La_{B}M′_{C}M″_{D}Zr_{E}O_{F}, Li_{A}La_{B}M′_{C}M″_{D}Ta_{E}O_{F}, or Li_{A}La_{B}M′_{C}M″_{D}Nb_{E}O_{F}, wherein 4<A<8.5, 1.5<B<4, 0≤C≤2, 0≤D≤2; 0≤E<2.5, 10<F<13, and M′ and M″ are each, independently in each instance selected from Ga, Al, Mo, W, Nb, Ga, Sb, Ca, Ba, Sr, Ce, Hf, Rb, and Ta, or LiₐLa_{b}Zr_{c}Al_{d}Me″ₑO_{f}, wherein 5<a<8.5; 2<b<4; 0<c≤2.5; 0≤d<2; 0≤e<2, and 10<f<13 and Me″ is a metal selected from Ga, Nb, Ta, V, W, Mo, and Sb and as otherwise described in U.S. Patent Application Publication No. U.S. 2015/0099190.

Also, lithium-stuffed garnets used herein include, but are not limited to, LiₓLa₃Zr₂O_{F}+yAl₂O₃, wherein x ranges from 5.5 to 9; and y ranges from 0.05 to 1. In these examples, subscripts x, y, and F are selected so that the garnet is charge neutral. In some examples x is 7 and y is 1.0. In some examples, x is 5 and y is 1.0. In some examples, x is 6 and y is 1.0. In some examples, x is 8 and y is 1.0. In some examples, x is 9 and y is 1.0. In some examples x is 7 and y is 0.35. In some examples, x is 5 and y is 0.35. In some examples, x is 6 and y is 0.35. In some examples, x is 8 and y is 0.35. In some examples, x is 9 and y is 0.35. In some examples x is 7 and y is 0.7. In some examples, x is 5 and y is 0.7. In some examples, x is 6 and y is 0.7. In some examples, x is 8 and y is 0.7. In some examples, x is 9 and y is 0.7. In some examples x is 7 and y is 0.75. In some examples, x is 5 and y is 0.75. In some examples, x is 6 and y is 0.75. In some examples, x is 8 and y is 0.75. In some examples, x is 9 and y is 0.75. In some examples x is 7 and y is 0.8. In some examples, x is 5 and y is 0.8. In some examples, x is 6 and y is 0.8. In some examples, x is 8 and y is 0.8. In some examples, x is 9 and y is 0.8. In some examples x is 7 and y is 0.5. In some examples, x is 5 and y is 0.5. In some examples, x is 6 and y is 0.5. In some examples, x is 8 and y is 0.5. In some examples, x is 9 and y is 0.5. In some examples x is 7 and y is 0.4. In some examples, x is 5 and y is 0.4. In some examples, x is 6 and y is 0.4. In some examples, x is 8 and y is 0.4. In some examples, x is 9 and y is 0.4. In some examples x is 7 and y is 0.3. In some examples, x is 5 and y is 0.3. In some examples, x is 6 and y is 0.3. In some examples, x is 8 and y is 0.3. In some examples, x is 9 and y is 0.3. In some examples x is 7 and y is 0.22. In some examples, x is 5 and y is 0.22. In some examples, x is 6 and y is 0.22. In some examples, x is 8 and y is 0.22. In some examples, x is 9 and y is 0.22. Also, lithium-stuffed garnets as used herein include, but are not limited to, LiₓLa₃Zr₂O₁₂+yAl₂O₃. In one embodiment, the Li-stuffed garnet herein has a composition of Li₇Li₃Zr₂O₁₂. In another embodiment, the Li-stuffed garnet herein has a composition of Li₇Zr₂O₁₂.Al₂O₃. In yet another embodiment, the Li-stuffed garnet herein has a composition of Li₇Li₃Zr₂O₁₂.0.22Al₂O₃. In yet another embodiment, the Li-stuffed garnet herein has a composition of Li₇Li₃Zr₂O₁₂.0.35Al₂O₃. In certain other embodiments, the Li-stuffed garnet herein has a composition of Li₇Li₃Zr₂O₁₂.0.5Al₂O₃. In another embodiment, the Li-stuffed garnet herein has a composition of Li₇Li₃Zr₂O₁₂.0.75Al₂O₃.

As used herein, the phrase “liquid electrolyte”, unless specified otherwise, refers to a Li⁺ conducting liquid electrolyte suitable for use in a lithium ion or lithium metal electrochemical cell or battery. A liquid electrolyte comprises at least one solvent and at least one Li-salt and provides a lithium conductivity of at least 10⁻⁵ S/cm at room temperature. A liquid electrolyte will often comprise more than one solvent. A liquid electrolyte may further comprise additives to improve stability. A liquid electrolyte is a liquid at room temperature (˜22° C.) and atmospheric pressure (i.e., 1 atm or 101,325 Pascals).

As used herein, the phrase “gel” refers to a material that has a storage modulus that exceeds the loss modulus as measured by rheometry. A gel may be a polymer swollen or infiltrated by a liquid, or a two-phase material with a porous polymer with pores occupied by liquid. A gel does not appreciably flow in response to gravity over short times (minutes). Examples include, but are not limited to, a PVDF-HFP with electrolyte solvent and salt, and PAN with electrolyte solvent and salt.

As used herein, the phrases “gel electrolyte” unless specified otherwise, refers to a suitable Li⁺ ion conducting gel-based electrolyte. A gel electrolyte may have a lithium ion conductivity of greater than 10⁻⁵S/cm at room temperature, a lithium transference number between 0.05-0.95, and a storage modulus greater than the loss modulus at some temperature. A gel electrolyte may comprise a polymer matrix, a solvent that gels the polymer, and a lithium containing salt that is at least partly dissociated into Li⁺ ions and anions. Alternately, a gel electrolyte may comprise a porous polymer matrix, a solvent that fills the pores, and a lithium containing salt that is at least partly dissociated into Li⁺ ions and anions where the pores have one length scale less than 10 μm.

As used herein, the term, “impermeable,” refers to the inability for a liquid electrolyte, gel electrolyte, or component thereof to substantially penetrate through that which is impermeable for the cycle life of the electrochemical cell. Herein, cycle life refers to the number of cycles used a given application. For example, if a battery is rated for 1,000 cycles, then the term impermeable means that the liquid electrolyte, gel electrolyte, or component thereof will not substantially penetrate through that which is impermeable for at least 1,000 cycles. Unless specified otherwise, a battery herein is assumed to have a 1,000 cycle life rating. In some examples, as used herein, the term “impermeable” also means that the seal transmits less than 1 g of electrolyte through 1 cm² of the seal cross-sectional area per year.

As used herein, the term “substantially penetrate” means penetrate to a degree that impacts performance or is detectible by an elemental analysis such as x-ray photoelectron spectroscopy (XPS), energy dispersive x-ray spectroscopy (EDS), and x-ray fluorescence (XRF) spectroscopy and the like. An impact on performance includes a capacity fade of more than 10% of the battery's rated capacity at a fixed C rate. If a product of a reaction between the liquid electrolyte or the gel electrolyte and a battery component other than the cathode is detected by XPS, EDS, or XRF, the seal around the cathode which should prevent such a reaction is said to be substantially penetrated by the liquid electrolyte or the gel electrolyte. XPS detection is the default method for making this determination absent an explicit recitation to perform EDS or XRF. Evidence that a reaction between the liquid electrolyte or the gel electrolyte and a battery component other than the cathode occurred may be include, but is not limited to, an XPS signal detecting a lithium-containing compound (e.g., a solid-electrolyte-interface, i.e., SEI, compound; as opposed to just lithium metal) in the anode.

As used herein, the term “LPSI” refers to a lithium conducting electrolyte comprising the elements Li, P, S, and I. More generally, it is understood to include aLi₂S+bP₂S_{y}+cLiX where X═Cl, Br, and/or I and where y=3-5 and where a/b=2.5-4.5 and where (a+b)/c=0.5-15.

As used herein, the term “rational number” refers to any number which can be expressed as the quotient or fraction (e.g., p/q) of two integers (e.g., p and q), with the denominator (e.g., q) not equal to zero. Example rational numbers include, but are not limited to, 1, 1.1, 1.52, 2, 2.5, 3, 3.12, and 7.

As used herein the term “making” refers to the process or method of forming or causing to form the object that is made. For example, making an energy storage electrode includes the process, process operations, process steps, or method of causing the electrode of an energy storage device to be formed. The end result of the operations constituting the making of the energy storage electrode is the production of a material that is functional as an electrode.

As used herein, the phrase “providing” refers to the provision of, generation or, presentation of, or delivery of that which is provided.

As used herein, the phrase “garnet-type electrolyte” refers to an electrolyte that includes a lithium-stuffed garnet material described herein as the ionic conductor.

As used herein, the phrase “subscripts and molar coefficients in the empirical formulas are based on the quantities of raw materials initially batched to make the described examples” means the subscripts, (e.g., 7, 3, 2, 12 in Li₇La₃Zr₂O₁₂ and the coefficient 0.35 in 0.35Al₂O₃) refer to the respective elemental ratios in the chemical precursors (e.g., LiOH, La₂O₃, ZrO₂, Al₂O₃) used to prepare a given material, (e.g., Li₇La₃Zr₂O₁₂.0.35Al₂O₃). As used here, the phrase “characterized by the formula” refers to a molar ratio of constituent atoms either as batched during the process for making that characterized material or as empirically determined. Subscripts herein refer to the molar ratios as batches unless specified otherwise to the contrary.

As used herein, the term “solvent” refers to a liquid that is suitable for dissolving or solvating a component or material described herein. For example, a solvent includes a liquid, e.g., nitrile or dinitrile solvent, which is suitable for dissolving a component, e.g., the salt, used in the electrolyte.

As used herein, the phrase “nitrile” or “nitrile solvent” refers to a hydrocarbon substituted by a cyano group, or a solvent which includes a cyano (i.e., —C≡N) substituent bonded to the solvent. Nitrile solvents may include dinitrile solvents.

Some exemplary nitrile and dinitrile solvents include, but are not limited to, adiponitrile (hexanedinitrile), acetonitrile, benzonitrile, butanedinitrile (succinonitrile), butyronitrile, decanenitrile, ethoxyacetonitrile, fluoroacetonitrile, glutaronitrile, hexanenitrile, heptanenitrile, heptanedinitrile, iso-butyronitrile, malononitrile (propanedinitrile or malonodinitrile), methoxyacetonitrile, nitroacetonitrile, nonanenitrile, nonanedinitrile, octanedinitrile (suberodinitrile), octanenitrile, propanenitrile, pentanenitrile, pentanedinitrile, sebaconitrile (decanedinitrile), succinonitrile, and combinations thereof.

As used herein, the phrase “organic sulfur-including solvent” refers to a solvent selected from ethyl methyl sulfone, dimethyl sulfone, sulfolane, allyl methyl sulfone, butadiene sulfone, butyl sulfone, methyl methanesulfonate, and dimethyl sulfite.

As used herein, voltage is set forth with respect to lithium (i.e., V vs. Li) metal unless stated otherwise.

As used herein, the term “lithium salt” refers to a lithium-containing compound that is a solid at room temperature that at least partially dissociates when immersed in a solvent such as EMC. Lithium salts may include but are not limited to LiPF₆, LiBOB, LiTFSi, LiFSI, LiAsF₆, LiClO₄, LiI, LiBETI, and LiBF₄.

As used herein, the term “carbonate solvent” refers to a class of solvents containing a carbonate group C(═O)(O⁻)₂. Carbonate solvents include but are not limited to ethylene carbonate, dimethyl carbonate, propylene carbonate, diethyl carbonate, ethyl methyl carbonate, dimethyl ethylene carbonate, isobutylene carbonate, nitroethyl carbonate, monofluoroethylene carbonate, fluoromethyl ethylene carbonate, 1,2-butylene carbonate, methyl propyl carbonate, and isopropyl methyl carbonate.

As used herein, area-specific resistance (ASR) is measured by electrochemical cycling (e.g., galvanostatic intermittent titration technique) using Arbin or Biologic instruments unless otherwise specified to the contrary.

As used herein, ionic conductivity is measured by electrical impedance spectroscopy methods known in the art.

As used herein, the term “film” refers to an object wherein the thickness of the film is substantially smaller than the width or the length of the object. The thickness of the film refers to the distance between the top and bottom faces of a film. As used herein, the top and bottom faces refer to the sides of the film having the largest surface area. As used herein, the term “film” may refer to an object that has been prepared via methods such as casting, such as via doctor blade, meyer rod, comma coater, gravure coater, microgravure, reverse comma coater, slot dye, slip or tape casting, and slurry casting, and coating, such as roll coating. As used herein, the term “film” does not refer to an object that has been prepared via powder pressing, hot-pressing, or dye-pressing. A film may have an average thickness dimensions of about 10 nm to about 100 μm. In some examples, a film may be less than about 1 μm, 10 μm or 50 μm in thickness. As used herein, a film, such as an oxide-metal film or a lithium-stuffed garnet-metal film, does not comprise powder on the surface of the film after sintering or formation of the film. A film may be adhered to a substrate. A film may not be adhered to a substrate. A film that is adhered to a substrate is often referred to as a coating.

The term “film” is not equivalent to a pellet. A film is not simply a thin pellet, as films and pellets are fundamentally different form factors. For example, a pellet is formed via sintering compacts such as compacts of pressed powder. Additionally, pellets may be polished after sintering. It is difficult, if at all possible, to polish films of a certain thickness, especially those less than 100 μm.

The term “lithium-stuffed garnet-metal film” refers to a film that is 0.5 to 100 μm in thickness and which includes a co-sintered amount of mixed lithium-stuffed garnet and a metal. The metal may be selected from the group consisting of Ni, Mg, Li, Fe, Al, Cu, Au, Ag, Pd, Pt, Ti, steel, alloys thereof, and combination thereof. The lithium-stuffed garnet and metal are mixed as powders and then co-sintered to form a film. In some examples, the film includes a uniform mixture of lithium-stuffed garnet and metal. The relative amounts of lithium-stuffed garnet and metal may vary by volume from 1% lithium-stuffed garnet up to 99% lithium-stuffed garnet with the remainder being the metal.

The term “ceramic-metal film” refers to a film that is 0.5 to 100 μm in thickness and which includes a co-sintered amount of mixed ceramic and metal. The metal may be selected from the group consisting of Ni, Mg, Li, Fe, Al, Cu, Au, Ag, Pd, Pt, alloys thereof, and combination thereof. The ceramic may be selected from alumina, silica, titania, lithium-stuffed garnet, lithium aluminate, aluminum hydroxide, an aluminosilicate, lithium zirconate, lanthanum aluminate, lanthanum zirconate, lanthanum oxide, lithium lanthanum oxide, zirconia, Li₂ZrO₃, xLi₂O-(l-x)SiO₂ (where x=0.01-0.99), aLi₂O-bB₂O₃-cSiO₂ (where a+b+c=l), LiLaO₂, LiAlO₂, Li₂O, Li₃PO₄, and combinations thereof. The ceramic and metal are mixed as powders and then co-sintered to form a film. In some examples, the film includes a uniform mixture of ceramic and metal. The relative amounts of ceramic and metal may vary by volume from 1% ceramic up to 99% ceramic with the remainder being the metal.

### III. ELECTROLYTES

a. Solid-State Electrolytes

A variety of solid-state electrolytes can be used with the electrochemical cells and devices disclosed herein.

Certain solid-state electrolytes compatible with Li metal negative electrodes are disclosed in, for example, those set forth in International PCT Patent Application No. PCT/US2014/059578, entitled GARNET MATERIALS FOR LI SECONDARY BATTERIES, filed Oct. 7, 2014, or in International PCT Patent Application No. PCT/US2014/059575, entitled GARNET MATERIALS FOR LI SECONDARY BATTERIES, also filed Oct. 7, 2014, the contents of each of which are herein incorporated by reference in their entirety for all purposes.

Other solid-state electrolytes include, but are not limited to, those electrolytes in International Patent Application Publication No. PCT/US2014/038283, filed May 16, 2014, and titled SOLID STATE CATHOLYTE OR ELECTROLYTE FOR BATTERY USING LIAMPBSc (M═Si, Ge, AND/OR Sn), which is incorporated by reference herein in its entirety

b. Gel Electrolytes

Certain gel electrolytes compatible with solid-state electrolytes and positive electrodes are disclosed in, for example, WO/2017/197406 entitled “SOLID ELECTROLYTE SEPARATOR BONDING AGENT” (PCT/US2017/032749 filed May 15, 2017), and US-2017-0331092-A1 entitled “SOLID ELECTROLYTE SEPARATOR BONDING AGENT” (U.S. application Ser. No. 15/595,755 filed May 15, 2017), the entire contents of both of which are herein incorporated by reference in its entirety for all purposes.

c. Liquid Electrolytes

Liquid electrolytes include but are not limited to those liquid electrolytes set forth in “Conductivity of electrolytes for rechargeable lithium batteries” Journal Power Sources 35 (1991) 59-82 by J. T. Dudley et. Al.; “Nonaqueous liquid electrolytes for lithium-based rechargeable batteries” Chem. Rev. 104 (2004) 4303-4417 by K. Xu; and “Electrolytes and interphases in Li-ion batteries and beyond” Chem. Rev. 114 (2014) 11503-11618 by K. Xu.

### IV. ELECTROCHEMICAL STACKS

In some examples, set forth herein an electrochemical stack comprising: a layer comprising lithium-stuffed garnet; a layer comprising a ceramic and a metal; and a metal sheet; wherein the layer comprising a ceramic and a metal is between and in contact with the layer comprising lithium-stuffed garnet and the metal sheet.

In some examples, including any of the foregoing, the metal sheet comprises a first portion and a second portion, wherein the metal sheet is adjacent to the layer comprising ceramic and a metal.

In some examples, including any of the foregoing, the layer comprising a ceramic and a metal is a layer in which the ceramic and the metal were sintered together.

In some examples, including any of the foregoing, the layer comprising a ceramic and a metal is a layer in which the ceramic and the metal were sintered together as power ceramic and powder metal.

In some examples, including any of the foregoing, when the stack is completely discharged, the electrochemical stack comprises a bilayer which comprises the layer comprising a lithium-stuffed garnet and the layer comprising a ceramic and a metal.

In some examples, including any of the foregoing, the stack further comprises a layer of lithium (Li) metal.

In some examples, including any of the foregoing, the stack further comprises a layer of Li metal between the layer comprising a lithium-stuffed garnet and the layer comprising a ceramic and a metal.

In some examples, including any of the foregoing, the ceramic comprises a lithium-stuffed garnet.

In some examples, including any of the foregoing, the layer comprising a ceramic and a metal comprises at least about 50% by molar ratio of a metal and at least about 20% by molar ratio of a ceramic.

In some examples, including any of the foregoing, the metal is selected from the group consisting of Ni, Mg, Li, Fe, Al, Cu, Au, Ag, Pd, Pt, Ti, steel, alloys thereof, and combination thereof.

In some examples, including any of the foregoing, the metal sheet comprises a perimeter that is adjacent to less than about 99% by surface area of said layer comprising a ceramic and a metal.

In some examples, including any of the foregoing, the metal perimeter is adjacent to less than about 50% by surface area of said said layer comprising a ceramic and a metal.

In some examples, including any of the foregoing, the stack further comprises a layer of Li metal.

In some examples, including any of the foregoing, the stack further comprises a layer of Li metal is between said layer comprising lithium-stuffed garnet and said layer comprising a ceramic and a metal

In some examples, including any of the foregoing, wherein in a charged state, said layer of Li metal has a thickness of at least about 10 μm, at least about 20 μm, at least about 30 μm, or at least about 20 μm. In some examples, the thickness of the Li metal is 10 μm. In some examples, the thickness of the Li metal is 20 μm. In some examples, the thickness of the Li metal is 30 μm. In some examples, the thickness of the Li metal is 40 μm. In some examples, the thickness of the Li metal is 50 μm. In some examples, the thickness of the Li metal is 60 μm. In some examples, the thickness of the Li metal is 70 μm. In some examples, the thickness of the Li metal is 80 μm. In some examples, the thickness of the Li metal is 90 μm. In some examples, the thickness of the Li metal is 100 μm. In some examples, the thickness of the Li metal is 15 μm. In some examples, the thickness of the Li metal is 25 μm. In some examples, the thickness of the Li metal is 35 μm. In some examples, the thickness of the Li metal is 45 μm. In some examples, the thickness of the Li metal is 55 μm. In some examples, the thickness of the Li metal is 65 μm. In some examples, the thickness of the Li metal is 75 μm. In some examples, the thickness of the Li metal is 85 μm. In some examples, the thickness of the Li metal is 95 μm.

In some examples, including any of the foregoing, said layer of Li metal has a thickness less than 100 μm.

In some examples, including any of the foregoing, layer comprising lithium-stuffed garnet has a thickness of at least about 10 μm, at least about 20 μm, at least about 30 μm, at least about 40 μm, at least about 50 μm, at least about 60 μm, at least about 70 μm, or at least about 80 μm. In some examples, the thickness of the layer comprising lithium-stuffed garnet is 10 μm. In some examples, the thickness of the layer comprising lithium-stuffed garnet is 20 μm. In some examples, the thickness of the layer comprising lithium-stuffed garnet is 30 μm. In some examples, the thickness of the layer comprising lithium-stuffed garnet is 40 μm. In some examples, the thickness of the layer comprising lithium-stuffed garnet is 50 μm. In some examples, the thickness of the layer comprising lithium-stuffed garnet is 60 μm. In some examples, the thickness of the layer comprising lithium-stuffed garnet is 70 μm. In some examples, the thickness of the layer comprising lithium-stuffed garnet is 80 μm. In some examples, the thickness of the layer comprising lithium-stuffed garnet is 90 μm. In some examples, the thickness of the layer comprising lithium-stuffed garnet is 100 μm. In some examples, the thickness of the layer comprising lithium-stuffed garnet is 15 μm. In some examples, the thickness of the layer comprising lithium-stuffed garnet is 25 μm. In some examples, the thickness of the layer comprising lithium-stuffed garnet is 35 μm. In some examples, the thickness of the layer comprising lithium-stuffed garnet is 45 μm. In some examples, the thickness of the layer comprising lithium-stuffed garnet is 55 μm. In some examples, the thickness of the layer comprising lithium-stuffed garnet is 65 μm. In some examples, the thickness of the layer comprising lithium-stuffed garnet is 75 μm. In some examples, the thickness of the layer comprising lithium-stuffed garnet is 85 μm. In some examples, the thickness of the layer comprising lithium-stuffed garnet is 95 μm.

In some examples, including any of the foregoing, layer comprising lithium-stuffed garnet has a thickness less than 100 μm.

In some examples, including any of the foregoing, the layer comprising a ceramic and a metal has a thickness of at least about 10 μm, at least about 20 μm, at least about 30 μm, at least about 40 μm, at least about 50 μm, at least about 60 μm, at least about 70 μm, or at least about 80 μm. In some examples, the thickness of the layer comprising a ceramic and metal is 10 μm. In some examples, the thickness of the layer comprising a ceramic and metal is 20 μm. In some examples, the thickness of the layer comprising a ceramic and metal is 30 μm. In some examples, the thickness of the layer comprising a ceramic and metal is 40 μm. In some examples, the thickness of the layer comprising a ceramic and metal is 50 μm. In some examples, the thickness of the layer comprising a ceramic and metal is 60 μm. In some examples, the thickness of the layer comprising a ceramic and metal is 70 μm. In some examples, the thickness of the layer comprising a ceramic and metal is 80 μm. In some examples, the thickness of the layer comprising a ceramic and metal is 90 μm. In some examples, the thickness of the layer comprising a ceramic and metal is 100 μm. In some examples, the thickness of the layer comprising a ceramic and metal is 15 μm. In some examples, the thickness of the layer comprising a ceramic and metal is 25 μm. In some examples, the thickness of the layer comprising a ceramic and metal is 35 μm. In some examples, the thickness of the layer comprising a ceramic and metal is 45 μm. In some examples, the thickness of the layer comprising a ceramic and metal is 55 μm. In some examples, the thickness of the layer comprising a ceramic and metal is 65 μm. In some examples, the thickness of the layer comprising a ceramic and metal is 75 μm. In some examples, the thickness of the layer comprising a ceramic and metal is 85 μm. In some examples, the thickness of the layer comprising a ceramic and metal is 95 μm.

In some examples, including any of the foregoing, the layer comprising a ceramic and a metal has a thickness less than 100 μm.

In some examples, set forth herein is an electrochemical stack comprising: a bilayer, wherein the bilayer comprises a solid-state separator and an ceramic-metal film; and a metal sheet, wherein the metal sheet comprises a first metal layer and a second metal layer, wherein at least a portion of the bilayer is adjacent to the metal sheet.

In some examples, including any of the foregoing, the ceramic-metal film may be an oxide-metal film. In some examples, the ceramic-metal film comprises a ceramic and a metal. In some examples, the volume percent of the ceramic is 10% and the volume percent of the metal is 90%. In some examples, the volume percent of the ceramic is 20% and the volume percent of the metal is 80%. In some examples, the volume percent of the ceramic is 30% and the volume percent of the metal is 70%. In some examples, the volume percent of the ceramic is 40% and the volume percent of the metal is 60%. In some examples, the volume percent of the ceramic is 50% and the volume percent of the metal is 50%. In some examples, the volume percent of the ceramic is 60% and the volume percent of the metal is 40%. In some examples, the volume percent of the ceramic is 70% and the volume percent of the metal is 30%. In some examples, the volume percent of the ceramic is 80% and the volume percent of the metal is 20%. In some examples, the volume percent of the ceramic is 90% and the volume percent of the metal is 10%. In some examples, the volume percent of the ceramic is 5% and the volume percent of the metal is 90%. In some examples, the volume percent of the ceramic is 15% and the volume percent of the metal is 85%. In some examples, the volume percent of the ceramic is 25% and the volume percent of the metal is 75%. In some examples, the volume percent of the ceramic is 35% and the volume percent of the metal is 65%. In some examples, the volume percent of the ceramic is 45% and the volume percent of the metal is 55%. In some examples, the volume percent of the ceramic is 55% and the volume percent of the metal is 45%. In some examples, the volume percent of the ceramic is 65% and the volume percent of the metal is 32%. In some examples, the volume percent of the ceramic is 75% and the volume percent of the metal is 25%. In some examples, the volume percent of the ceramic is 85% and the volume percent of the metal is 15%. In some examples, the volume percent of the ceramic is 95% and the volume percent of the metal is 5%.

In some examples, including any of the foregoing, the ceramic-metal film comprises an oxide and a metal. In some examples, the volume percent of the oxide is 10% and the volume percent of the metal is 90%. In some examples, the volume percent of the oxide is 20% and the volume percent of the metal is 80%. In some examples, the volume percent of the oxide is 30% and the volume percent of the metal is 70%. In some examples, the volume percent of the oxide is 40% and the volume percent of the metal is 60%. In some examples, the volume percent of the oxide is 50% and the volume percent of the metal is 50%. In some examples, the volume percent of the oxide is 60% and the volume percent of the metal is 40%. In some examples, the volume percent of the oxide is 70% and the volume percent of the metal is 30%. In some examples, the volume percent of the oxide is 80% and the volume percent of the metal is 20%. In some examples, the volume percent of the oxide is 90% and the volume percent of the metal is 10%. In some examples, the volume percent of the oxide is 5% and the volume percent of the metal is 90%. In some examples, the volume percent of the oxide is 15% and the volume percent of the metal is 85%. In some examples, the volume percent of the oxide is 25% and the volume percent of the metal is 75%. In some examples, the volume percent of the oxide is 35% and the volume percent of the metal is 65%. In some examples, the volume percent of the oxide is 45% and the volume percent of the metal is 55%. In some examples, the volume percent of the oxide is 55% and the volume percent of the metal is 45%. In some examples, the volume percent of the oxide is 65% and the volume percent of the metal is 32%. In some examples, the volume percent of the oxide is 75% and the volume percent of the metal is 25%. In some examples, the volume percent of the oxide is 85% and the volume percent of the metal is 15%. In some examples, the volume percent of the oxide is 95% and the volume percent of the metal is 5%.

In some examples, including any of the foregoing, the ceramic-metal film may be an oxide-metal film. In some examples, the ceramic-metal film comprises a ceramic and a metal. In some examples, the weight percent of the ceramic is 10% and the weight percent of the metal is 90%. In some examples, the weight percent of the ceramic is 20% and the weight percent of the metal is 80%. In some examples, the weight percent of the ceramic is 30% and the weight percent of the metal is 70%. In some examples, the weight percent of the ceramic is 40% and the weight percent of the metal is 60%. In some examples, the weight percent of the ceramic is 50% and the weight percent of the metal is 50%. In some examples, the weight percent of the ceramic is 60% and the weight percent of the metal is 40%. In some examples, the weight percent of the ceramic is 70% and the weight percent of the metal is 30%. In some examples, the weight percent of the ceramic is 80% and the weight percent of the metal is 20%. In some examples, the weight percent of the ceramic is 90% and the weight percent of the metal is 10%. In some examples, the weight percent of the ceramic is 5% and the weight percent of the metal is 90%. In some examples, the weight percent of the ceramic is 15% and the weight percent of the metal is 85%. In some examples, the weight percent of the ceramic is 25% and the weight percent of the metal is 75%. In some examples, the weight percent of the ceramic is 35% and the weight percent of the metal is 65%. In some examples, the weight percent of the ceramic is 45% and the weight percent of the metal is 55%. In some examples, the weight percent of the ceramic is 55% and the weight percent of the metal is 45%. In some examples, the weight percent of the ceramic is 65% and the weight percent of the metal is 32%. In some examples, the weight percent of the ceramic is 75% and the weight percent of the metal is 25%. In some examples, the weight percent of the ceramic is 85% and the weight percent of the metal is 15%. In some examples, the weight percent of the ceramic is 95% and the weight percent of the metal is 5%.

In some examples, including any of the foregoing, the ceramic-metal film comprises an oxide and a metal. In some examples, the weight percent of the oxide is 10% and the weight percent of the metal is 90%. In some examples, the weight percent of the oxide is 20% and the weight percent of the metal is 80%. In some examples, the weight percent of the oxide is 30% and the weight percent of the metal is 70%. In some examples, the weight percent of the oxide is 40% and the weight percent of the metal is 60%. In some examples, the weight percent of the oxide is 50% and the weight percent of the metal is 50%. In some examples, the weight percent of the oxide is 60% and the weight percent of the metal is 40%. In some examples, the weight percent of the oxide is 70% and the weight percent of the metal is 30%. In some examples, the weight percent of the oxide is 80% and the weight percent of the metal is 20%. In some examples, the weight percent of the oxide is 90% and the weight percent of the metal is 10%. In some examples, the weight percent of the oxide is 5% and the weight percent of the metal is 90%. In some examples, the weight percent of the oxide is 15% and the weight percent of the metal is 85%. In some examples, the weight percent of the oxide is 25% and the weight percent of the metal is 75%. In some examples, the weight percent of the oxide is 35% and the weight percent of the metal is 65%. In some examples, the weight percent of the oxide is 45% and the weight percent of the metal is 55%. In some examples, the weight percent of the oxide is 55% and the weight percent of the metal is 45%. In some examples, the weight percent of the oxide is 65% and the weight percent of the metal is 32%. In some examples, the weight percent of the oxide is 75% and the weight percent of the metal is 25%. In some examples, the weight percent of the oxide is 85% and the weight percent of the metal is 15%. In some examples, the weight percent of the oxide is 95% and the weight percent of the metal is 5%.

In some examples, including any of the foregoing, the ceramic in the ceramic-metal film may be selected from alumina, silica, titania, lithium-stuffed garnet, lithium aluminate, aluminum hydroxide, an aluminosilicate, lithium zirconate, lanthanum aluminate, lanthanum zirconate, lanthanum oxide, lithium lanthanum oxide, zirconia, Li₂ZrO₃, xLi₂O-(l-x)SiO₂ (where x=0.01-0.99), aLi₂O-bB₂O₃-cSiO₂ (where a+b+c=l), LiLaO₂, LiAlO₂, Li₂O, Li₃PO₄, and combinations thereof.

In some embodiments, including any of the foregoing, the lithium-stuffed garnet-metal film contains a first area and a second area, wherein the first area and the second area comprise a similar composition.

In some embodiments, including any of the foregoing, the electrochemical cells include a series of electrochemical stacks. In certain examples, each electrochemical stack includes, or shares, any one of: a positive electrode, a liquid electrolyte or gel electrolyte, a solid-state electrolyte, and a Li metal negative electrode. In some of these examples, the electrochemical stacks share a Li metal negative electrode by stacking the electrochemical stacks in an electrically parallel manner.

Set forth herein are electrochemical cells that include positive electrodes having active materials (e.g., NMC) and a liquid electrolyte in the positive electrode. In some examples, the electrochemical cells also have a solid-state electrolyte separator. In some examples, the seal prevents the liquid electrolyte from migrating or creeping around the solid-state electrolyte separator and reacting with the negative electrode. In some examples, the seal prevents the liquid electrolyte from evaporating, vaporizing or volatilizing from the cathode and then condensing on the anode.

In some examples, set forth herein is an electrochemical stack comprising: a layer comprising lithium-stuffed garnet; a layer comprising a ceramic and a metal; and a metal sheet comprising a first portion and a second portion, wherein the metal sheet is adjacent to the layer comprising ceramic and a metal.

In some examples, including any of the foregoing, the lithium-stuffed garnet-metal film contains a first area and a second area, wherein the first area and the second area comprise different compositions. In some embodiments, including any of the foregoing, the first area of the lithium-stuffed garnet-metal film comprises a first metal powder and lithium-stuffed garnet powder. In some embodiments, including any of the foregoing, the first area of the lithium-stuffed garnet-metal film comprises at least about 50% by molar ratio of the first metal powder and at least about 20% by molar ratio of the lithium-stuffed garnet powder. In some embodiments, including any of the foregoing, second area of the lithium-stuffed garnet-metal film comprises at least about 50% by molar ratio of a second metal powder.

In some examples, including any of the foregoing, first metal powder comprises Ni, Cu, Al, iron, titanium, steel, alloys, or combinations thereof. In some embodiments, the second metal powder comprises Ni, Cu, Al, iron, titanium, steel, alloys, or combinations thereof.

In some examples, including any of the foregoing, the metal powder is Ni, Mg, Li, Fe, Al, Cu, Au, Ag, Pd, Pt, Ti, steel, alloys thereof, or combination thereof

In some examples, including any of the foregoing, at least a portion of the lithium-stuffed garnet-metal film is adjacent to at least a portion of the second metal layer. In some examples, including any of the foregoing, at least 5% by surface area of lithium-stuffed garnet-metal film is adjacent to at least a portion of the second metal layer. In some examples, including any of the foregoing, the metal perimeter is adjacent to less than about 99% by surface area of the lithium-stuffed garnet-metal film. In some examples, including any of the foregoing, the metal perimeter is adjacent to less than about 50% by surface area of the lithium-stuffed garnet-metal film. In some examples, including any of the foregoing, the metal perimeter comprises Ni, Cu, Al, steel, alloys, or combinations thereof. In some examples, including any of the foregoing, the metal perimeter has a melting temperature of less than about 800° C. In some examples, including any of the foregoing, the metal perimeter has a thickness of at least about 1 nm. In some examples, including any of the foregoing, the metal perimeter has a thickness of no greater than about 1 cm.

In some examples, including any of the foregoing, the metal sheet comprises Ni, Cu, Al, steel, alloys, or combinations thereof. In some examples, including any of the foregoing, the metal sheet has a thickness of at least about 1 nm. In some examples, including any of the foregoing, the electrochemical stack further comprises a layer of Li metal. In some examples, including any of the foregoing, the layer of Li metal has a thickness of at least about 20 μm. In some examples, including any of the foregoing, the lithium-stuffed garnet film comprises Li_{A}La_{B}M′_{c}M″_{D}Zr_{E}O_{F}, Li_{A}La_{B}M′_{C}M″_{D}Ta_{E}O_{F}, or Li_{A}La_{B}M′_{C}M″_{D}Nb_{E}O_{F}, wherein 4<A<8.5, 1.5<B<4, 0≤C≤2, 0≤D≤2; 0≤E≤2, 10<F≤13, and M′ and M″ are each, independently in each instance selected from Al, Mo, W, Nb, Ga, Sb, Ca, Ba, Sr, Ce, Hf, Rb, and Ta. In some examples, including any of the foregoing, the lithium-stuffed garnet film comprises LiₐLa_{b}Zr_{c}Al_{d}Me″ₑO_{f}, wherein 5<a<7.7; 2<b<4; 0<c≤2.5; 0≤d≤2; 0≤e<2, 10<f<13 and Me″ is a metal selected from Nb, Ta, V, W, Mo, and Sb.

In some examples, including any of the foregoing, the lithium-stuffed garnet film comprises LiₓLa₃Zr₂O₁₂.yAl₂O₃, wherein x is from 5.5 to 9, and y is from 0.05 to 1.0. In some examples, including any of the foregoing, the lithium-stuffed garnet film comprises a molar ratio of Al₂O₃:LiₓLa₃Zr₂O₁₂ of at least about 0.35. In some examples, including any of the foregoing, the lithium-stuffed garnet powder comprises Li_{A}La_{B}M′_{c}M″_{D}Zr_{E}O_{F}, Li_{A}La_{B}M′_{C}M″_{D}Ta_{E}O_{F}, or Li_{A}La_{B}M′_{C}M″_{D}Nb_{E}O_{F}, wherein 4<A<8.5, 1.5<B<4, 0≤C≤2, 0≤D≤2; 0≤E≤2, 10<F≤13, and M′ and M″ are each, independently in each instance selected from Al, Mo, W, Nb, Ga, Sb, Ca, Ba, Sr, Ce, Hf, Rb, and Ta. In some examples, including any of the foregoing, the lithium-stuffed garnet powder comprises LiₐLa_{b}Zr_{c}Al_{d}Me″ₑO_{f}, wherein 5<a<7.7; 2<b<4; 0≤c≤2.5; 0≤d≤2; 0≤e≤2, 10<f<13 and Me″ is a metal selected from Nb, Ta, V, W, Mo, and Sb.

In an aspect, the present disclosure provides a battery comprising an electrochemical stack, wherein the electrochemical stack comprises a bilayer and metal sheet: wherein the bilayer comprises a lithium-stuffed garnet film and a lithium-stuffed garnet-metal film; and wherein the metal sheet comprises a first metal layer and a second metal layer, wherein at least a portion of the bilayer is adjacent to the lithium-stuffed garnet-metal film. In some examples, including any of the foregoing, the battery further comprises a layer of Li metal. In some examples, including any of the foregoing, the layer of Li metal is between the metal foil layer and the lithium-stuffed garnet-metal film. In some examples, including any of the foregoing, wherein in a charged state, the layer of Li metal has a thickness of at least about 10 μm. In some examples, including any of the foregoing, wherein in a discharged state, the layer of Li metal has a thickness of at most about 10 μm.

In an aspect, the present disclosure provides a method of making an electrochemical stack comprising: applying a metal sheet to the bilayer, wherein the bilayer comprises a lithium-stuffed garnet film and a lithium-stuffed garnet-metal film; wherein the metal sheet comprises a first metal layer and a second metal layer. In some examples, including any of the foregoing, the application comprises heating the bilayer and the metal sheet at a temperature less than about 800° C. In some examples, including any of the foregoing, the metal perimeter is adjacent to less than about 99% by surface area of the lithium-stuffed garnet-metal film.

In some examples, including any of the foregoing, a solid-state separator may be lithium-stuffed garnet, LBHI(N), LPSX, LiPON, or LiI. In some examples, including any of the foregoing, a solid-state separator comprises lithium-stuffed garnet. In some examples, including any of the foregoing, a solid-state separator comprises lithium-stuffed garnet film. In some examples, including any of the foregoing, a solid-state separator is not a lithium-stuffed garnet pellet.

In some examples, including any of the foregoing, an oxide-metal film comprises an oxide and a metal. In some examples, including any of the foregoing, an oxide of an oxide-metal film may be an oxide electrolyte. In some examples, including any of the foregoing, an oxide of an oxide-metal film may be a lithium-stuffed garnet. In some examples, including any of the foregoing, the oxide-metal film comprises an oxide and a metal that has been combined and sintered to form the oxide-metal film. As used herein, when an oxide-metal film comprises certain types of powders, the powders are used in the formation of the oxide-metal film. That is, the powders are mixed and subsequently sintered or heated to form the oxide-metal film.

In some examples, including any of the foregoing, the present disclosure provides an electrochemical stack comprising: a bilayer, wherein the bilayer comprises a lithium-stuffed garnet film and a lithium-stuffed garnet-metal film; and a metal sheet, wherein the metal sheet comprises a first metal layer and a second metal layer, wherein at least a portion of the bilayer is adjacent to the metal sheet.

In some examples, including any of the foregoing, a metal sheet effectively isolates and protects a lithium metal negative electrode from exposure to either, or both, a liquid electrolyte or a gel electrolyte.

In some examples, including any of the foregoing, the oxide-metal film contains a first area and a second area. In some examples, including any of the foregoing, the first area and the second area of an oxide-metal film together form the oxide-metal film. In other words, In some examples, including any of the foregoing, together, the first area of an oxide-metal film and the second area of an oxide metal film are the oxide-metal film.

In some examples, including any of the foregoing, the first area and the second area comprise a similar composition. In some examples, including any of the foregoing, the oxide-metal film contains a first area and a second area, wherein the first area and the second area comprise the same composition. In some examples, including any of the foregoing, the oxide-metal film contains a first area and a second area, wherein the first area and the second area comprise different compositions. The first area and second area of an oxide-metal film may be made via a similar process, or, in some cases, made in the same procedure or method.

In some examples, including any of the foregoing, the lithium-stuffed garnet-metal film contains a first area and a second area, wherein the first area and the second area comprise a similar composition. In some examples, including any of the foregoing, the lithium-stuffed garnet-metal film contains a first area and a second area, wherein the first area and the second area comprise the same composition. In some examples, including any of the foregoing, the lithium-stuffed garnet-metal film contains a first area and a second area, wherein the first area and the second area comprise different compositions. The first area and second area of a lithium-stuffed garnet-metal film may be made via a similar process, or, in some cases, made in the same procedure or method.

In some example, the oxide-metal film comprises oxide powder and metal powder that have been combined and sintered to form the oxide-metal film. In some cases, the oxide-metal film comprises oxide powder and metal powder in various ratios, wherein the ratios may be based on molar, weight, or volumetric ratios. In some cases, the molar ratio of oxide powder to metal powder in a oxide-metal film is about 10:1, 9:1, 8:1, 7:1, 6:1, 5:1, 4:1, 3:1, 2:1, 1:1, 1:2, 1:3, 1:4, 1:5, 1:6, 1:7, 1:8, 1:9, or 1:10. In some cases, the molar ratio of oxide powder to metal powder in a oxide-metal film is from about 1:1 to about 1:10, about 1:2 to about 1:9, about 1:2 to about 1:6, or about 1:2 to about 1:4.

In some examples, including any of the foregoing, the lithium-stuffed garnet-metal film comprises lithium-stuffed garnet powder and metal powder that has been combined and sintered. In some cases, the lithium-stuffed garnet-metal film comprises lithium-stuffed garnet powder and metal powder in various ratios, wherein the ratios may be based on molar, weight, or volumetric ratios. In some cases, the molar ratio of lithium-stuffed garnet powder to metal powder in a lithium-stuffed garnet-metal film is about 10:1, 9:1, 8:1, 7:1, 6:1, 5:1, 4:1, 3:1, 2:1, 1:1, 1:2, 1:3, 1:4, 1:5, 1:6, 1:7, 1:8, 1:9, or 1:10. In some cases, the molar ratio of lithium-stuffed garnet powder to metal powder in a lithium-stuffed garnet-metal film is from about 1:1 to about 1:10, about 1:2 to about 1:9, about 1:2 to about 1:6, or about 1:2 to about 1:4.

In some cases, the amount of lithium-stuffed garnet powder in a lithium-stuffed garnet-metal film can be described by a weight percent. In some cases, the amount of lithium-stuffed garnet powder in a lithium-stuffed garnet-metal film can be at least about 1%, 5%, 10%, 20%, 30%, 40% w/w or more. In some cases, the amount of lithium-stuffed garnet powder in a lithium-stuffed garnet-metal film is less than about 50%, 40%, 30%, 20%, 10%, or 5% w/w. In some cases, the amount of lithium-stuffed garnet powder in a lithium-stuffed garnet-metal film prior to sintering is from about 10% to 50%, about 20% to 40%, or about 30% w/w.

In some examples, including any of the foregoing, a first area of the lithium-stuffed garnet-metal film comprises a first metal powder and lithium-stuffed garnet powder. In some examples, including any of the foregoing, a first area of the lithium-stuffed garnet-metal film comprises at least about 50% of a first metal powder and at least about 20% of a lithium-stuffed garnet powder. In some examples, including any of the foregoing, a first area of the lithium-stuffed garnet-metal film comprises at least about 60%, 70%, 80%, 90%, or more of a first metal powder. In some cases, the lithium-stuffed garnet-metal film is a round shape, an oval shape, a square shape, or a rectangular shape. In some examples, including any of the foregoing, the first area of the lithium-stuffed garnet-metal film that comprises a first metal powder is the perimeter, or frame, of the lithium-stuffed garnet-metal film. In some cases, a first area of the lithium-stuffed garnet-metal film that comprises a first metal powder is a disc shape or a square or rectangular perimeter or frame of the film. In some cases, the first area of the lithium-stuffed garnet-metal film is the majority of the surface of the lithium-stuffed garnet-metal film.

In some examples, including any of the foregoing, a second area of the lithium-stuffed garnet-metal film comprises a second metal powder and lithium-stuffed garnet powder. In some examples, including any of the foregoing, a second area of the lithium-stuffed garnet-metal film comprises at least about 50% by mole of a second metal powder and at least about 20% by mole of a lithium-stuffed garnet powder. In some examples, including any of the foregoing, a second area of the lithium-stuffed garnet-metal film comprises at least about 60%, 70%, 80%, 90%, or more by mole of a second metal powder. In some cases, the lithium-stuffed garnet-metal film is a round shape, an oval shape, a square shape, or a rectangular shape. In some examples, including any of the foregoing, the second area of the lithium-stuffed garnet-metal film that comprises a second metal powder is the perimeter or frame of the lithium-stuffed garnet-metal film. In some cases, a second area of the lithium-stuffed garnet-metal film that comprises a second metal powder is a disc shape or a square or rectangular perimeter or frame of the film. In some cases, the second area of the lithium-stuffed garnet-metal film is the majority of the surface of the lithium-stuffed garnet-metal film. In some cases, the second area of the lithium-stuffed garnet-metal film is at least about 50%, 60%, 70%, 80%, 90%, by mole or more of the lithium-stuffed garnet-metal film. In some cases, the second area of the lithium-stuffed garnet-metal film is from about 60% to 99%, 70% to 99%, 80% to 99%, 90% to about 99%, or 90% to about 95% by mole.

In some examples, including any of the foregoing, a first metal powder can comprise nickel powder, copper powder, aluminum powder, iron powder, titanium powder, steel, alloys, or combinations thereof. In some examples, including any of the foregoing, a second metal powder can comprise nickel powder, copper powder, aluminum powder, iron powder, titanium powder, steel, alloys, or combinations thereof.

As used herein, lithium-stuffed garnets, include, but are not limited to, Li_{7.0}La₃(Zr₁+N_{bt2}+Taₜ₃)O₁₂+0.35Al₂O₃; wherein (t1+t2+t3=2) so that the La:(Zr/Nb/Ta) ratio is 3:2. Also, lithium-stuffed garnets used herein include, but are not limited to, LiₓLa₃Zr₂O_{F}+yAl₂O₃, wherein x ranges from 5.5 to 9; and y ranges from 0.05 to 1. In these examples, subscripts x, y, and F are selected so that the garnet is charge neutral. In some examples x is 7 and y is 1.0. In some examples, including any of the foregoing, x is 5 and y is 1.0. In some examples, including any of the foregoing, x is 6 and y is 1.0. In some examples, including any of the foregoing, x is 8 and y is 1.0. In some examples, including any of the foregoing, x is 9 and y is 1.0. In some examples x is 7 and y is 0.35. In some examples, including any of the foregoing, x is 5 and y is 0.35. In some examples, including any of the foregoing, x is 6 and y is 0.35. In some examples, including any of the foregoing, x is 8 and y is 0.35. In some examples, including any of the foregoing, x is 9 and y is 0.35. In some examples x is 7 and y is 0.7. In some examples, including any of the foregoing, x is 5 and y is 0.7. In some examples, including any of the foregoing, x is 6 and y is 0.7. In some examples, including any of the foregoing, x is 8 and y is 0.7. In some examples, including any of the foregoing, x is 9 and y is 0.7. In some examples x is 7 and y is 0.75. In some examples, including any of the foregoing, x is 5 and y is 0.75. In some examples, including any of the foregoing, x is 6 and y is 0.75. In some examples, including any of the foregoing, x is 8 and y is 0.75. In some examples, including any of the foregoing, x is 9 and y is 0.75. In some examples x is 7 and y is 0.8. In some examples, including any of the foregoing, x is 5 and y is 0.8. In some examples, including any of the foregoing, x is 6 and y is 0.8. In some examples, including any of the foregoing, x is 8 and y is 0.8. In some examples, including any of the foregoing, x is 9 and y is 0.8. In some examples x is 7 and y is 0.5. In some examples, including any of the foregoing, x is 5 and y is 0.5. In some examples, including any of the foregoing, x is 6 and y is 0.5. In some examples, including any of the foregoing, x is 8 and y is 0.5. In some examples, including any of the foregoing, x is 9 and y is 0.5. In some examples x is 7 and y is 0.4. In some examples, including any of the foregoing, x is 5 and y is 0.4. In some examples, including any of the foregoing, x is 6 and y is 0.4. In some examples, including any of the foregoing, x is 8 and y is 0.4. In some examples, including any of the foregoing, x is 9 and y is 0.4. In some examples x is 7 and y is 0.3. In some examples, including any of the foregoing, x is 5 and y is 0.3. In some examples, including any of the foregoing, x is 6 and y is 0.3. In some examples, including any of the foregoing, x is 8 and y is 0.3. In some examples, including any of the foregoing, x is 9 and y is 0.3. In some examples x is 7 and y is 0.22. In some examples, including any of the foregoing, x is 5 and y is 0.22. In some examples, including any of the foregoing, x is 6 and y is 0.22. In some examples, including any of the foregoing, x is 8 and y is 0.22. In some examples, including any of the foregoing, x is 9 and y is 0.22. Also, lithium-stuffed garnets as used herein include, but are not limited to, LiₓLa₃Zr₂O₁₂+yAl₂O₃. In one embodiment, the Li-stuffed garnet herein has a composition of Li₇Li₃Zr₂O₁₂. In another embodiment, the Li-stuffed garnet herein has a composition of Li₇Li₃Zr₂O₁₂.Al₂O₃. In yet another embodiment, the Li-stuffed garnet herein has a composition of Li₇Li₃Zr₂O₁₂.0.22Al₂O₃. In yet another embodiment, the Li-stuffed garnet herein has a composition of Li₇Li₃Zr₂O₁₂.0.35Al₂O₃. In certain other examples, the Li-stuffed garnet herein has a composition of Li₇Li₃Zr₂O₁₂.0.5Al₂O₃. In another embodiment, the Li-stuffed garnet herein has a composition of Li₇Li₃Zr₂O₁₂.0.75Al₂O₃.

In some examples, including any of the foregoing, an electrochemical stack comprises a metal sheet, wherein the metal sheet comprises a first metal layer and a second metal layer. A metal layer can comprise nickel, copper, aluminum, steel, alloys, or combinations thereof. In some cases, a first metal layer may be a sheet, a thin layer, a panel, an overlay, a foil, or a surface. In some cases, a first metal layer has a round shape, an oval shape, a square shape, or a rectangular shape.

In some cases, a first metal layer comprises Ni, Cu, Al, Sn, In, Ag, Au, steel, alloys, or combinations thereof. In some cases, a first metal layer is a sheet of metal. In some cases, a first metal layer is a sheet of aluminum. In some cases, a first metal layer is a sheet of nickel. In some cases, a first metal layer may be malleable. In some cases, a first metal layer may have a measurable yield strength, wherein the yield strength is at least about 1 megapascal (MPa), 5 MPa, 10 MPa, 50 MPa, 100 MPa, 150 MPa, 200 MPa, 250 MPa, 300 MPa, 400 MPa, 500 MPa, 600 MPa, 700 MPa, 800 MPa, 900 MPa, or more. In some cases, a first metal layer may have a yield strength from about 10 MPa to 500 MPa, 50 MPa to 400 MPa, or 150 MPa to 300 MPa.

In some examples, including any of the foregoing, a metal sheet may act as a seal to separate the anode from electrolyte within an electrochemical cell. In some embodiment, a metal sheet may act as an impermeable seal, wherein an impermeable seal may transmit less than 0.5 g of electrolyte through 1 cm² of the seal per year. In some examples, including any of the foregoing, an impermeable seal may transmit less than 0.1 g of electrolyte through 1 cm² of the seal per year. In some examples, including any of the foregoing, an impermeable seal may transmit less than 10 mg of electrolyte through 1 cm² of the seal cross-sectional area per year. In some examples, including any of the foregoing, an impermeable seal may transmit less than 1 mg of electrolyte through 1 cm² of the seal cross-sectional area per year. In some examples, including any of the foregoing, an impermeable seal may transmit less than 100 μg of electrolyte through 1 cm² of the seal cross-sectional area per year. In some examples, including any of the foregoing, an impermeable seal may transmit less than 1 g of electrolyte through 1 cm² of the seal per month. In some examples, including any of the foregoing, an impermeable seal may transmit less than 1 g of electrolyte through 1 cm² of the seal per day. In some examples, including any of the foregoing, a metal sheet that may act as a seal can be measured to have a certain hermeticity. A hermeticity value may be measured to determine the effectiveness of the seal. In some examples, including any of the foregoing, a metal sheet may act as a hermetic seal.

In some cases, a first metal layer has a thickness of about 0.1 μm to about 100 μm. In some examples, including any of the foregoing, the thickness of the first metal layer is about 0.1 μm to about 90 μm, about 0.2 μm to about 50 μm, about 0.3 μm to about 40 μm, about 0.4 μm to about 30 μm, about 0.5 μm to about 20 μm, about 0.5 μm to about 10 μm. In some examples, including any of the foregoing, the thickness of the first metal layer is at least about 0.1 μm, 0.5 μm, 1 μm, 2 μm, 3 μm, 4 μm, 5 μm, 6 μm, 7 μm, 8 μm, 9 μm, or 10 μm.

In some cases, a second metal layer may have a round shape, an oval shape, a square shape, a rectangular shape, a disc or donut shape, a perimeter or frame shape, a square perimeter shape, or an oval perimeter shape. In some cases, a second metal layer is a layer that comprises a cavity in the middle. In some cases, a second metal layer is a perimeter of an oval shape or a perimeter of a square shape. In some cases, the second metal layer is smaller is area than the first metal layer.

In some cases, one surface of a second metal layer has a surface area of at least about 1 mm², 10 mm², 20 mm², 30 mm², 40 mm², 50 mm², 60 mm², 70 mm², 80 mm², 90 mm², 100 mm², 200 mm², 300 mm², 400 mm², 500 mm², 600 mm², 700 mm², 800 mm², 900 mm², 10 cm², 50 cm², 100 cm², 200 cm², 300 cm², 400 cm², 500 cm², 600 cm², 700 cm², 800 cm², 900 cm², 0.1 m², 0.5 m², 1 m², or larger. In some cases, a second metal layer has a surface area from about 10 mm² to 1 m², 100 mm² to 0.5 m², 10 cm² to 0.1 m², 100 mm² to 500 cm², 200 mm² to 900 cm², or 100 mm² to 300 cm². In some cases, a second metal layer has a surface area on one surface from about 1 cm² to 0.1 m². In some cases, a second metal layer has a surface area on one surface from about 10 cm² to 500 cm². In some cases, a second metal layer has a surface area on one surface from about 10 cm² to 100 cm². In some cases, a second metal layer has a surface area on one surface from about 200 mm² to 900 cm².

In some cases, a second metal layer comprises Ni, Cu, Al, Zn, Bi, Sb, Sn, In, Ag, Au, Pb, steel, alloys, or combinations thereof. In some cases, a second metal layer comprises at least one or more of the following: nickel, tin, indium, and silver. In some cases, a second metal layer comprises tin at a weight percentage of about 50%, 60%, 70%, 80%, or more. In some cases, a second metal layer comprises tin at a weight percentage of about 50% to 90%, 50% to 80%, or 60% to 80%. In some cases, a second metal layer comprises indium at a weight percentage of about 5%, 10%, 15%, 20%, or more. In some cases, a second metal layer comprises indium at a weight percentage of about 1% to 30%, 5% to 25%, or 10% to 20%. In some cases, a second metal layer comprises silver at less than about 10%. In some cases, a second metal layer comprises gold at less than about 10%. In some cases, a second metal layer comprises lead at less than about 10%. In some cases, a second metal layer comprises nickel at less than about 20%.

In some cases, a second metal layer has a thickness of about 0.1 μm to about 100 μm. In some examples, including any of the foregoing, the thickness of the second metal layer is about 0.1 μm to about 90 μm, about 0.2 μm to about 50 μm, about 0.3 μm to about 40 μm, about 0.4 μm to about 30 μm, about 0.5 μm to about 20 μm, about 0.5 μm to about 10 μm. In some examples, including any of the foregoing, the thickness of the second metal layer is at least about 0.1 μm, 0.5 μm, 1 μm, 2 μm, 3 μm, 4 μm, 5 μm, 6 μm, 7 μm, 8 μm, 9 μm, or 10 μm.

In some examples, including any of the foregoing, at least a portion of the lithium-stuffed garnet-metal film is adjacent to at least a portion of the metal perimeter. In some cases, the portion of the lithium-stuffed garnet-metal film that is adjacent to a portion of the metal perimeter is at least about 0.1%, 0.5%, 1%, 2%, 3%, 4%, 5%, 6%, 7%, 8%, 9%, 10%, or more of the surface area of one face of the lithium-stuffed garnet-metal film. In some cases, the portion of the lithium-stuffed garnet-metal film that is adjacent to a portion of the metal perimeter is from about 0.1% to 10%, 0.2% to 9%, 0.3% to 8%, or 1% to 8% of the surface area of one face of the lithium-stuffed garnet-metal film. In some cases, the second area of the lithium-stuffed garnet-metal film is the portion of the lithium-stuffed garnet-metal film that is adjacent to a portion of the metal perimeter.

In some cases, the metal perimeter is adjacent to less than about 99% of the surface area of one face of the lithium-stuffed garnet-metal film. In some cases, the amount of metal perimeter adjacent to the lithium-stuffed garnet-metal film is less than about 95%, 90%, 80%, 70%, 60%, 50%, or 40% of the surface area of one face of the lithium-stuffed garnet-metal film.

In some examples, including any of the foregoing, a metal sheet comprises Ni, Cu, Al, Sn, In, Ag, Au, steel, alloys, or combinations thereof. In some examples, including any of the foregoing, a metal sheet comprises at least about 50%, 60%, 70%, or more nickel by mole.

In some cases, a portion of the bilayer or metal sheet may be coated with flux. Flux may be in a solid form, and may consist of powders. Flux may comprise carbonate and silicate materials. In some cases, coating a portion of a bilayer or metal sheet with flux may ease processing and processability, may prevent oxidation, may melt, and may outgas.

In some examples, including any of the foregoing, a metal sheet has a melting temperature of less than about 1000° C. In some examples, including any of the foregoing, a metal sheet has a melting temperature of about 900° C., 800° C., 700° C., 600° C., 500° C., 400° C., 300° C., 200° C. or less. In some examples, including any of the foregoing, a metal sheet has a melting temperature of about 50° C. to 300° C., 100° C. to 250° C., 150° C. to 250° C., about 150° C. to 250° C., or about 150° C. to 200° C.

In some cases, a metal sheet has a thickness of about 0.1 μm to about 100 μm. In some examples, including any of the foregoing, the thickness of the first metal layer is about 0.1 μm to about 90 μm, about 0.2 μm to about 50 μm, about 0.3 μm to about 40 μm, about 0.4 μm to about 30 μm, about 0.5 μm to about 20 μm, about 0.5 μm to about 10 μm. In some examples, including any of the foregoing, the thickness of the first metal layer is at least about 0.1 μm, 0.5 μm, 1 μm, 2 μm, 3 μm, 4 μm, 5 μm, 6 μm, 7 μm, 8 μm, 9 μm, or 10 μm.

In some cases, one surface of a first metal layer has a surface area of at least about 1 mm², 2 mm², 3 mm², 4 mm², 5 mm², 6 mm², 7 mm², 8 mm², 9 mm², 10 mm², 20 mm², 30 mm², 40 mm², 50 mm², 60 mm², 70 mm², 80 mm², 90 mm², 100 mm², or larger. In some cases, a first metal layer has a surface area from about 1 mm² to 100 m², or 15 mm² to 50 mm².

In some examples, including any of the foregoing, the size of a metal sheet is approximately the size of a bilayer in terms of the width and length of the metal sheet. In some examples, including any of the foregoing, a ratio of the area of a metal sheet to the area of a bilayer is about 1:1. In some examples, including any of the foregoing, a ratio of the area of a metal sheet to the area of a bilayer is about 1:1.1, 1:1.3, 1:1.5, 1:2, 1:3, or 1:4. In some examples, including any of the foregoing, a ratio of the area of a metal sheet to the area of a bilayer is about 1:0.9, 1:0.8, 1:0.7, 1:0.6, or 1:0.5.

In some examples, including any of the foregoing, the surface area of one surface of a metal sheet is approximately the surface area of one surface of a bilayer. In some examples, including any of the foregoing, a ratio of the surface area of one surface of a metal sheet to the surface area of one surface of a bilayer is about 1:1. In some examples, including any of the foregoing, a ratio of the surface area of one surface of a metal sheet to the surface area of one surface of a bilayer is about 1:1.1, 1:1.3, 1:1.5, 1:2, 1:3, or 1:4. In some examples, including any of the foregoing, a ratio of the surface area of one surface of a metal sheet to the surface area of one surface of a bilayer is about 1:0.9, 1:0.8, 1:0.7, 1:0.6, or 1:0.5.

In some examples, including any of the foregoing, an electrochemical stack comprises a layer of lithium metal. In some examples, including any of the foregoing, the electrochemical stack comprises a layer of lithium metal prior to initial charge. In some examples, including any of the foregoing, the electrochemical stack comprises a layer of lithium metal after initial charge. In some examples, including any of the foregoing, the electrochemical stack comprises a layer of lithium metal after discharge. In some cases, a layer of lithium may have a thickness of at least about 1 μm, 2 μm, 3 μm, 4 μm, 5 μm, 10 μm, 15 μm, 20 μm or more. In some examples, including any of the foregoing, a layer of Li metal has a thickness of at least about 20 μm. In some examples, including any of the foregoing, a layer of lithium metal may have a thickness from 1 μm to about 50 μm, 5 μm to 40 μm, 10 μm to 30 μm, or 10 μm to 25 μm. In some examples, including any of the foregoing, a layer of Li metal has a thickness of about 20 μm, 25 μm, or 30 μm.

In some examples, including any of the foregoing, upon first or initial charge of an electrochemical cell disclosed herein, a bilayer or a portion thereof may distort or crack. In some cases, upon initial charge of a cell, a portion of the oxide-metal layer or the lithium-stuffed garnet-metal layer may crack, tear, distort, or lose some of the original shape.

In some examples, including any of the foregoing, a lithium-stuffed garnet film of the present disclosure comprises Li_{A}La_{B}M′_{c}M″_{D}Zr_{E}O_{F}, Li_{A}La_{B}M′_{C}M″_{D}Ta_{E}O_{F}, or Li_{A}La_{B}M′_{C}M″_{D}Nb_{E}O_{F}, wherein 4<A<8.5, 1.5<B<4, 0≤C≤2, 0≤D≤2; 0≤E≤2, 10<F≤13, and M′ and M″ are each, independently in each instance selected from Al, Mo, W, Nb, Ga, Sb, Ca, Ba, Sr, Ce, Hf, Rb, and Ta. In some examples, including any of the foregoing, a lithium-stuffed garnet film LiₐLa_{b}Zr_{c}Al_{d}Me″ₑO_{f}, wherein 5<a<7.7; 2<b<4; 0<c≤2.5; 0≤d≤2; 0≤e<2, 10<f<13 and Me″ is a metal selected from Nb, Ta, V, W, Mo, and Sb. In some examples, including any of the foregoing, a lithium-stuffed garnet film comprises aluminum, such as aluminum oxide. In some cases, a lithium-stuffed garnet film comprises LiₓLa₃Zr₂O₁₂.yAl₂O₃, wherein x is from 5.5 to 9, and y is from 0.05 to 1.0. In some examples, including any of the foregoing, a lithium-stuffed garnet film comprises a molar ratio of Al₂O₃:LiₓLa₃Zr₂O₁₂ of 0.1, 0.2, 0.3, 0.4, 0.5, 0.6, or more. In some examples, including any of the foregoing, a lithium-stuffed garnet film comprises a molar ratio of Al₂O₃:LiₓLa₃Zr₂O₁₂ from 0.1 to 0.6, 0.2 to 0.5, 0.3 to 0.5, or 0.3 to 0.4. In some examples, including any of the foregoing, a lithium-stuffed garnet film comprises a molar ratio of Al₂O₃:LiₓLa₃Zr₂O₁₂ of about 0.3. In some examples, including any of the foregoing, a lithium-stuffed garnet film comprises a molar ratio of Al₂O₃:LiₓLa₃Zr₂O₁₂ of about 0.4. In some examples, including any of the foregoing, a lithium-stuffed garnet film comprises a molar ratio of Al₂O₃:LiₓLa₃Zr₂O₁₂ of about 0.5. In some examples, including any of the foregoing, a lithium-stuffed garnet film comprises aluminum, wherein a molar ratio of Al₂O₃:LiₓLa₃Zr₂O₁₂ of about 0.5, 0.4, 0.3, 0.2, 0.1, or less.

In some examples, including any of the foregoing, a lithium-stuffed garnet film is prepared from a slurry comprising a lithium-stuffed garnet powder. In some examples, including any of the foregoing, a lithium-stuffed garnet powder may be Li_{A}La_{B}M′_{c}M″_{D}Zr_{E}O_{F}, Li_{A}La_{B}M′_{C}M″_{D}Ta_{E}O_{F}, or Li_{A}La_{B}M′_{C}M″_{D}Nb_{E}O_{F}, wherein 4<A<8.5, 1.5<B≤4, 0≤C≤2, 0≤D≤2; 0≤E≤2, 10<F≤13, and M′ and M″ are each, independently in each instance selected from Al, Mo, W, Nb, Ga, Sb, Ca, Ba, Sr, Ce, Hf, Rb, and Ta. In some examples, including any of the foregoing, lithium-stuffed garnet powder comprises LiₐLa_{b}Zr_{c}Al_{d}Me″ₑO_{f}, wherein 5<a<7.7; 2<b<4; 0≤c≤2.5; 0≤d≤2; 0≤e<2, 10<f<13 and Me″ is a metal selected from Nb, Ta, V, W, Mo, and Sb.

In some examples, including any of the foregoing, set forth herein is an electrochemical stack, comprising: a solid-state electrolyte; a positive electrode including a liquid electrolyte or a gel electrolyte; a positive electrode current collector; and a metal sheet impermeable to the liquid electrolyte or the gel electrolyte that bonds to the bilayer, wherein the bilayer comprises the solid-state electrolyte.

In some examples, including any of the foregoing, the electrochemical stack may further include a lithium (Li) metal negative electrode.

In some examples, including any of the foregoing, the electrochemical stack may further include a negative electrode current collector.

In some examples, including any of the foregoing, the electrochemical stack container includes conductive tab leads.

In some examples, including any of the foregoing, the diameter of the solid-state electrolyte is greater than the diameter of the lithium metal negative electrode.

In some examples, including any of the foregoing, the diameter of the solid-state electrolyte is greater than the diameter of the positive electrode.

In some examples, including any of the foregoing, the width or diameter of the solid-state electrolyte is greater than either of the diameter of the lithium metal negative electrode or of the positive electrode.

In some examples, including any of the foregoing, the diameter of the solid-state electrolyte is greater than either of the diameter of the lithium metal negative electrode or of the positive electrode. In some examples, including any of the foregoing, the width of the solid-state electrolyte is greater than either of the diameter of the lithium metal negative electrode or of the positive electrode.

In some examples, including any of the foregoing, the width or diameter of the solid-state electrolyte is greater than the width or diameter of the lithium metal negative electrode.

In some examples, including any of the foregoing, the diameter of the solid-state electrolyte is greater than the width or diameter of the lithium metal negative electrode.

In some examples, including any of the foregoing, the diameter of the solid-state electrolyte is greater than the width or diameter of the lithium metal negative electrode.

In some examples, including any of the foregoing, the width or diameter of the solid-state electrolyte is greater than the width or diameter of the positive electrode.

In some examples, including any of the foregoing, the width of the solid-state electrolyte is greater than the width or diameter of the positive electrode.

In some examples, including any of the foregoing, the diameter of the solid-state electrolyte is greater than the width or diameter of the positive electrode.

In some examples, including any of the foregoing, the solid-state electrolyte has raised edges.

Also included is an electrochemical cell including at least one or more electrochemical stacks set forth herein.

### V. ELECTROCHEMICAL CELLS

In some examples, set forth herein is an electrochemical cell, which includes a (1) container, (2) at least one electrochemical stack in the container, in which the electrochemical stack comprises: a bilayer, wherein the bilayer comprises a lithium-stuffed garnet film and a lithium-stuffed garnet-metal film; and a metal sheet, wherein the metal sheet comprises a first metal layer and a second metal layer, wherein at least a portion of the bilayer is adjacent to the lithium-stuffed garnet-metal film.

In some examples, including any of the foregoing, the electrochemical cell includes a lithium (Li) metal negative electrode.

In some examples, including any of the foregoing, the electrochemical cell includes a negative electrode current collector.

In some examples, including any of the foregoing, the electrochemical cell includes a negative electrode current collector and Li metal between and in contact with the solid-state electrolyte and the negative electrode current collector.

In some examples, including any of the foregoing, the electrochemical cell includes a disc-shaped solid-state electrolyte.

In some examples, including any of the foregoing, the electrochemical cell includes a disc-shaped positive electrode.

In some examples, including any of the foregoing, the disc-shaped solid-state electrolyte is at least 0.25 times as large as the diameter of the disc-shaped positive electrode.

In some examples, including any of the foregoing, the width of the solid-state electrolyte is larger than the width of the positive electrode.

In some examples, including any of the foregoing, the solid-state electrolyte is selected from the group consisting of a lithium-stuffed garnet, a sulfide electrolyte doped with oxygen, a sulfide electrolyte including oxygen, a lithium aluminum titanium oxide, a lithium aluminum titanium phosphate, a lithium aluminum germanium phosphate, a lithium aluminum titanium oxy-phosphate, a lithium lanthanum titanium oxide perovskite, a lithium lanthanum tantalum oxide perovskite, a lithium lanthanum titanium oxide perovskite, an antiperovskite, a LISICON, a LI-S-O-N, lithium aluminum silicon oxide, a Thio-LISICON, a lithium-substituted NASICON, a LIPON, or a combination, mixture, or multilayer thereof.

In some examples, including any of the foregoing, the solid-state electrolyte includes a lithium lanthanum titanium oxide characterized by the empirical formula, Li₃ₓLa_{2/3-x}TiO₃, wherein x is a rational number from 0 to 2/3. In some examples, including any of the foregoing, the solid-state electrolyte includes a lithium lanthanum titanium oxide characterized by the empirical formula, Li₃ₓLa_{2/3-x}TiⱼTaₖO₃, wherein x is a rational number from 0 to 2/3, and wherein subscripts j+k=1. In some examples, including any of the foregoing, the solid-state electrolyte includes a lithium lanthanum titanium oxide characterized by a perovskite crystal structure. In some examples, including any of the foregoing, the solid-state electrolyte includes an antiperovskite characterized by the empirical formula, Li₃OX wherein X is Cl, Br, or combinations thereof. In some examples, including any of the foregoing, the solid-state electrolyte includes a LISICON characterized by the empirical formula, Li(Me′ₓ,Me″_{y})(PO₄) wherein Me′ and Me″ are selected from Si, Ge, Sn or combinations thereof and wherein 0≤x≤1; wherein 0≤y≤1, and wherein x+y=1. In some examples, including any of the foregoing, the solid-state electrolyte includes a thio-LISICON characterized by the empirical formula, Li_{3.25}Ge_{0.25}P_{0.75}S₄.

In some examples, including any of the foregoing, the solid-state electrolyte includes a thio-LISICON characterized by the empirical formula, Li₄₋ₓM₁₋ₓPₓS₄ or Li₁₀MP₂S₁₂, wherein M is selected from Si, Ge, Sn, or combinations thereof; and wherein 0≤x≤1. In some examples, including any of the foregoing, the solid-state electrolyte includes a lithium aluminum titanium phosphate characterized by the empirical formula, Li₁₊ₓAlₓTi₂₋ₓ(PO₄), wherein 0≤x≤2. In some examples, including any of the foregoing, the solid-state electrolyte includes a lithium aluminum germanium phosphate characterized by the empirical formula, Li_{1.5}Al_{0.5}Ge_{1.5}(PO₄). In some examples, including any of the foregoing, the solid-state electrolyte includes a LI-S-O-N characterized by the empirical formula, LiₓS_{y}O_{z}N_{w}, wherein x, y, z, and w, are a rational number from 0.01 to 1.

In some examples, including any of the foregoing, the solid-state electrolyte includes a material characterized by the empirical formula LiₓLa₃Zr₂Oₕ+yAl₂O₃, wherein 3≤x≤8, 0≤y≤1, and 6≤h≤15; and wherein subscripts x and h, and coefficient y is selected so that the electrolyte separator is charge neutral. In some of these examples, solid-state electrolyte is doped with Ga, Nb, or Ta.

In some examples, an electrochemical cell includes a liquid electrolyte or gel electrolyte, wherein the liquid electrolyte or gel electrolyte may be: (1) a lithium salt selected from the group consisting of LiPF₆, LiBOB, LiTFSi, LiBF₄, LiClO₄, LiAsF₆, LiFSI, LiI, and a combination thereof; or (2) a solvent selected from the group consisting of ethylene carbonate (EC), diethylene carbonate, diethyl carbonate, dimethyl carbonate (DMC), ethyl-methyl carbonate (EMC), tetrahydrofuran (THF), γ-Butyrolactone (GBL), fluoroethylene carbonate (FEC), fluoromethyl ethylene carbonate (FMEC), trifluoroethyl methyl carbonate (F-EMC), fluorinated 3-(1,1,2,2-tetrafluoroethoxy)-1,1,2,2-tetrafluoropropane/1,1,2,2-Tetrafluoro-3-(1,1,2,2-tetrafluoroethoxy)propane (F-EPE), fluorinated cyclic carbonate (F-AEC), propylene carbonate (PC), dioxolane, acetonitrile (ACN), succinonitrile, adiponitrile, hexanedinitrile, pentanedinitrile, acetophenone, isophorone, benzonitrile, dimethyl sulfate, sulfolane, dimethyl sulfoxide (DMSO) ethyl acetate, methyl butyrate, methyl propionate, dimethyl ether (DME), diethyl ether, propylene carbonate, dioxolane, glutaronitrile, gamma butyl-lactone, and combinations thereof.

In some examples, including any of the foregoing, the liquid electrolyte or gel electrolyte includes a polymer selected from the group consisting of polyacrylonitrile (PAN), polypropylene, polyethylene oxide (PEO), polymethyl methacrylate (PMMA), polyvinyl chloride (PVC), polyvinyl pyrrolidone (PVP), polyethylene oxide poly(allyl glycidyl ether) PEO-AGE, polyethylene oxide 2-methoxyethoxy)ethyl glycidyl ether (PEO-MEEGE), polyethylene oxide 2-methoxyethoxy)ethyl glycidyl poly(allyl glycidyl ether) (PEO-MEEGE-AGE), polysiloxane, polyvinylidene fluoride (PVDF), polyvinylidene fluoride hexafluoropropylene (PVDF-HFP), rubbers such as ethylene propylene (EPR), nitrile rubber (NPR), styrene-butadiene-rubber (SBR), polybutadiene polymer, polybutadiene rubber (PB), polyisobutadiene rubber (PIB), polyisoprene rubber (PI), polychloroprene rubber (CR), acrylonitrile-butadiene rubber (NBR), polyethyl acrylate (PEA), polyvinylidene fluoride (PVDF), polyethylene (e.g., low density linear polyethylene), and combinations thereof.

In some examples, including any of the foregoing, the liquid electrolyte or gel electrolyte includes: (1) a solvent selected from the group consisting of ethylene carbonate (EC), propylene carbonate (PC), dimethyl carbonate (DMC), methylene carbonate, and combinations thereof; and (2) a polymer selected from the group consisting of PVDF-HFP, PAN, and combinations thereof; and (3) a lithium salt selected from the group consisting of LiPF₆, LiBOB, LFTSi, and combinations thereof.

In some examples, including any of the foregoing, the lithium salt is selected from LiPF₆, LiBOB, LFTSi, and combinations thereof.

In some examples, including any of the foregoing, the lithium salt is LiPF6 at a concentration of 0.5 M to 2M. In some examples, including any of the foregoing, the lithium salt is LiTFSI at a concentration of 0.5 M to 2M. In some examples, including any of the foregoing, the lithium is present at a concentration from 0.01 M to 10 M. In some examples, including any of the foregoing, the solvent is a 1:1 w/w mixture of EC:PC.

In some examples, including any of the foregoing, the positive electrode includes a lithium intercalation material, a lithium conversion material, or both a lithium intercalation material and a lithium conversion material.

In some examples, including any of the foregoing, the intercalation material is selected from the group consisting of a nickel manganese cobalt oxide (NMC), a nickel cobalt aluminum oxide (NCA), Li(NiCoAl)O₂, a lithium cobalt oxide (LCO), a lithium manganese cobalt oxide (LMCO), a lithium nickel manganese cobalt oxide (LMNCO), a lithium nickel manganese oxide (LNMO), Li(NiCoMn)O₂, LiMn₂O₄, LiCoO₂, and LiMn₂₋ₐNiₐO₄, wherein a is from 0 to 2, or LiMPO₄, wherein M is Fe, Ni, Co, or Mn.

In some examples, including any of the foregoing, the lithium conversion material is selected from the group consisting of FeF₂, NiF₂, FeOₓF₃₋₂ₓ, wherein subscript x is from 0 to 3/2, FeF₃, MnF₃, CoF₃, CuF₂ materials, alloys thereof, and combinations thereof.

In some examples, including any of the foregoing, the electrochemical cell is pressurized. In some cases, the pressure applied to the electrochemical cell is about 5 kilopascals (kPa), 10 kPa, 50 kPa, 100 kPa, 1 megapascal (MPa), 1 MPa, 2 MPa, 3 MPa, 4 MPa, 5 MPa, or 10 MPa. In some cases, the pressure applied to the electrochemical cell is from about 5 kPa to 10 MPa, 10 kPa to 5 MPa, 50 kPa to 4 MPa, or 100 MPa to 1 MPa. In some cases, the pressure applied is about 170 kPa, 700 kPa, 1.7 MPa, or 7 MPa.

In some examples, including any of the foregoing, the width or diameter of the solid-state electrolyte is greater than the width or diameter of the lithium metal negative electrode. In some examples, including any of the foregoing, the width of the solid-state electrolyte is greater than the width of the lithium metal negative electrode. In some examples, including any of the foregoing, the diameter of the solid-state electrolyte is greater than the diameter of the lithium metal negative electrode. In some examples, including any of the foregoing, the width or diameter of the solid-state electrolyte is greater than the width or diameter of the positive electrode. In some examples, including any of the foregoing, the width of the solid-state electrolyte is greater than the width of the positive electrode. In some examples, including any of the foregoing, the diameter of the solid-state electrolyte is greater than the diameter of the positive electrode.

In some examples, including any of the foregoing, the width or diameter of the solid-state electrolyte is greater than either of the width or diameter of the lithium metal negative electrode or of the positive electrode. In some examples, including any of the foregoing, the width of the solid-state electrolyte is greater than either of the width of the lithium metal negative electrode or the width of the positive electrode. In some examples, including any of the foregoing, the diameter of the solid-state electrolyte is greater than either of the diameter of the lithium metal negative electrode or the diameter of the positive electrode.

In some examples, including any of the foregoing, the solid-state electrolyte has raised edges. In some examples, including any of the foregoing, the solid-state electrolyte has coated edges.

In some examples, including any of the foregoing, the coated edges include a coating selected from parylene, polypropylene, polyethylene, alumina, Al₂O₃, ZrO₂, TiO₂, SiO₂, a binary oxide, La₂Zr₂O₇, a lithium carbonate species, or a glass, wherein the glass is selected from SiO₂—B₂O₃, or Al₂O₃.

In some examples, including any of the foregoing, the solid-state electrolyte has tapered edges.

Also set forth herein is a battery which includes at least one electrochemical cell set forth herein.

Also set forth herein is a device, which includes a battery set forth herein or an electrochemical cell set forth herein.

In one embodiment, set for herein is an electrochemical cell comprising:

a positive electrode current collector;
a positive electrode comprising a liquid electrolyte;
a bilayer;
a negative electrode current collector; and
a metal sheet.

In some examples, including any of the foregoing examples, the electrochemical cell comprises a layer of lithium in direct contact with and between the bilayer and the negative electrode current collector.

In some examples, including any of the foregoing examples, the negative metal electrode is a lithium (Li) metal negative electrode.

In some examples, including any of the foregoing examples, the liquid electrolyte is a gel electrolyte.

In some examples, including any of the foregoing examples, the liquid electrolyte comprises a lithium salt, a polymer, and a solvent.

In some examples, including any of the foregoing examples, the positive electrode comprises a lithium intercalation material, a lithium conversion material, or both a lithium intercalation material and a lithium conversion material. In some examples, the intercalation material is selected from the group consisting of a nickel manganese cobalt oxide (NMC), a nickel cobalt aluminum oxide (NCA), Li(NiCoAl)O₂, a lithium cobalt oxide (LCO), a lithium manganese cobalt oxide (LMCO), a lithium nickel manganese cobalt oxide (LMNCO), a lithium nickel manganese oxide (LNMO), Li(NiCoMn)O₂, LiMn₂O₄, LiCoO₂, and LiMn₂₋₋ₐNiₐO₄, wherein a is from 0 to 2, or LiMPO₄, wherein M is Fe, Ni, Co, or Mn. In some examples, the lithium conversion material is selected from the group consisting of FeF₂, NiF₂, FeOₓF₃₋₂ₓ, FeF₃, MnF₃, CoF₃, CuF₂ materials, alloys thereof, and combinations thereof.

In some examples, including any of the foregoing examples, the first or second layer of the bilayer solid-state electrolyte further comprises a member selected from the group consisting of tin (Sn), germanium (Ge), arsenic (As), silicon (Si), chlorine (Cl), bromine (Br), and a combination thereof. In some examples, the first layer of the bilayer solid-state electrolyte further comprises a member selected from the group consisting of tin (Sn), germanium (Ge), arsenic (As), silicon (Si), chlorine (CO, bromine (Br), and a combination thereof.

In some examples, including any of the foregoing examples, the solid-state separator is rectangular shaped. In some examples, including any of the foregoing examples, the solid-state separator is disc-shaped. In some examples, including any of the foregoing examples, the positive electrode is rectangular shaped. In some examples, including any of the foregoing examples, the positive electrode is disc-shaped.

In some examples, including any of the foregoing examples, the thickness of the positive electrode current collector or negative electrode current collector is about 5 μm to about 100 μm, about 5 μm to about 90 μm, about 5 μm to about 80 μm, about 5 μm to about 70 μm, about 5 μm to about 60 μm, about 5 μm to about 50 μm, about 5 μm to about 40 μm, about 5 μm to about 30 μm, about 5 μm to about 20 μm.

In some examples, including any of the foregoing examples, diameter, length or width of the solid-state electrolyte is greater than the diameter, length or width of the lithium metal negative electrode. In some examples, including any of the foregoing examples, diameter, length or width of the solid-state electrolyte is greater than the diameter, length or width of the positive electrode. In some examples, including any of the foregoing examples, diameter, length or width of the solid-state electrolyte is greater than the diameter, length or width of the negative electrode.

In some examples, including any of the foregoing examples, the solid-state electrolyte has coated edges. In some examples, the coated edges comprise a coating selected from parylene, polypropylene, polyethylene, alumina, Al₂O₃, ZrO₂, TiO₂, SiO₂, a binary oxide, La₂Zr₂O₇, a lithium carbonate species, and a glass, wherein the glass is selected from SiO₂—B₂O₃, or Al₂O₃. In some examples, the coating is parylene. In some examples, the coating is polypropylene. In some examples, the coating is polyethylene. In some examples, the coating is alumina. In some examples, the coating is Al₂O₃. In some examples, the coating is ZrO₂. In some examples, the coating is TiO₂. In some examples, the coating is SiO₂. In some examples, the coating is a binary oxide. In some examples, the coating is La₂Zr₂O₇. In some examples, the coating is a lithium carbonate species. In some examples, the coating is a glass.

In some examples, including any of the foregoing examples, the positive or negative electrode current collector is made of a material selected from the group consisting of carbon (C)-coated nickel (Ni), nickel (Ni), copper (Cu), aluminum (Al), stainless steel, Palladium (Pd), and Platinum (Pt). In some examples, the material is carbon (C)-coated nickel (Ni). In some examples, the material is nickel (Ni). In some examples, the material is copper (Cu). In some examples, the material is aluminum (Al). In some examples, the material is stainless steel. In some examples, the material is Palladium (Pd). In some examples, the material is Platinum (Pt).

In some examples, including any of the foregoing examples, the positive electrode current collector is an Al metal current collector.

In some examples, including any of the foregoing examples, the positive electrode current collector is a C-coated Ni metal current collector.

In another embodiment, set forth herein is a rechargeable battery comprising any of the electrochemical cells set forth herein.

In another embodiment, set forth herein is an electric vehicle comprising the rechargeable battery set forth herein.

### VI. ELECTROCHEMICAL CELLS & ARCHITECTURES

In some examples, set forth herein is a half-cell. In some examples, set forth herein is a full-cell. In some examples, set forth herein is a symmetric-cell.

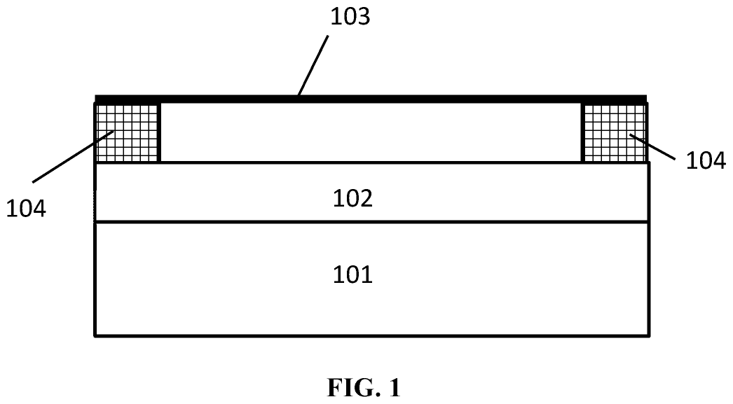

FIGS. 1-5 show examples of electrochemical cells and architectures as described herein.

FIG. 1 is not drawn to scale. In FIG. 1, a portion of an electrochemical cell is illustrated in a cross-sectional schematic. In this embodiment, the electrochemical stack is discharged. Lithium-stuffed garnet film 101 is adjacent to lithium-stuffed garnet-metal film 102. Together, lithium-stuffed garnet film 101 and lithium-stuffed garnet-metal film 102 form a bilayer of an electrochemical stack. A metal sheet comprises a first metal layer 103 and a second metal layer 104. As illustrated in FIG. 1, a portion of the second metal layer 104 of the metal sheet is adjacent to the lithium-stuffed garnet-metal film 102. In some cases, as shown in FIG. 1, there may be a gap between lithium-stuffed garnet-metal film 102 and first metal layer 103. The gap may be filled with atmospheric gas. In some cases, the gap may be filled with inert gas, such as nitrogen or argon. When lithium metal plates between 101 and 102, the gap can accommodate the flexing and swelling of 102.

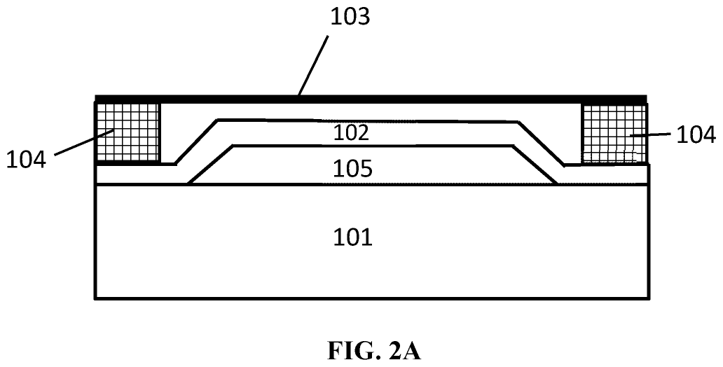

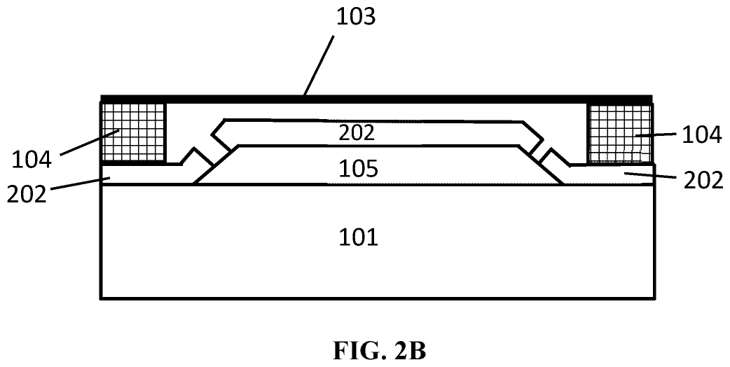

FIGS. 2A and 2B are not drawn to scale. FIG. 2A is another cross-sectional schematic of the electrochemical cell of FIG. 1. In this embodiment, the electrochemical stack is charged. Lithium-stuffed garnet film 101 is adjacent to lithium-stuffed garnet-metal film 102. Together, lithium-stuffed garnet film 101 and lithium-stuffed garnet-metal film 102 form a bilayer of an electrochemical stack. A metal sheet comprises a first metal layer 103 and a second metal layer 104. As illustrated in FIG. 2, a portion of the second metal layer 104 of the metal sheet is adjacent to the lithium-stuffed garnet-metal film 102. A layer of lithium metal 105 is adjacent to a portion of lithium-stuffed garnet-metal film 102. In some cases, as shown in FIG. 2A, there may be a gap between lithium-stuffed garnet-metal film 102 and first metal layer 103. The gap may be filled with atmospheric gas. In some cases, the gap may be filled with inert gas, such as nitrogen or argon. Compared with FIG. 1, FIG. 2A shows that the gap can accommodate the flexing and swelling of 102 when lithium plates between 101 and 102.

FIG. 2B is another cross-sectional schematic of the electrochemical cell of FIG. 1. In this embodiment, the electrochemical stack is charged. Lithium-stuffed garnet film 101 is adjacent to lithium-stuffed garnet-metal film 202. Together, lithium-stuffed garnet film 101 and lithium-stuffed garnet-metal film 202 form a bilayer of an electrochemical stack. A metal sheet comprises a first metal layer 103 and a second metal layer 104. As illustrated in FIG. 2, a portion of the second metal layer 104 of the metal sheet is adjacent to the lithium-stuffed garnet-metal film 202. A layer of lithium metal 105 is adjacent to a portion of lithium-stuffed garnet-metal film 202. In some cases, a portion of the lithium-stuffed garnet-metal film 202 may have a crack or tear in the film. In some cases, as shown in FIG. 2B, there may be a gap between lithium-stuffed garnet-metal film 202 and first metal layer 103. The gap may be filled with atmospheric gas. In some cases, the gap may be filled with inert gas, such as nitrogen or argon.

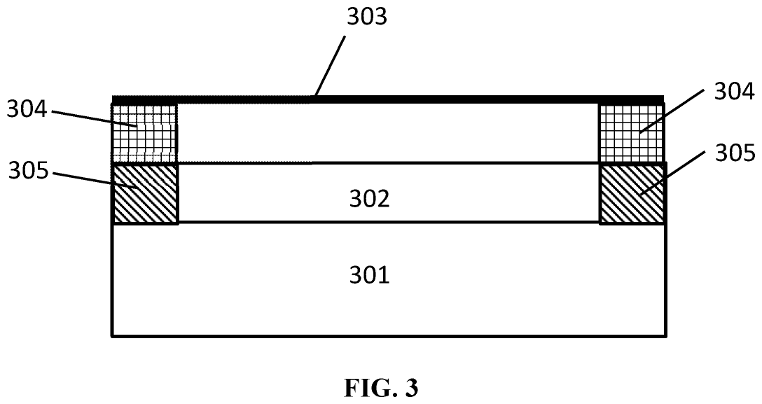

FIG. 3 is not drawn to scale. FIG. 3 shows a cross-sectional schematic of a portion of an electrochemical cell. In this embodiment, the portion of the electrochemical cell is discharged. A lithium-stuffed garnet-metal film comprises a first area 302 and a second area 305. Together, the first area 302 and the second area 305 are the lithium-stuffed garnet-metal film. The lithium-stuffed garnet-metal film comprises 302 and 305 are adjacent to the lithium-stuffed garnet film 301. Together, lithium-stuffed garnet film 301 and lithium-stuffed garnet-metal film areas 302 and 305 form a bilayer of an electrochemical stack. A metal sheet comprises a first metal layer 303 and a second metal layer 304. As illustrated in FIG. 3, a portion of the second metal layer 304 of the metal sheet is adjacent to the second area of the lithium-stuffed garnet-metal film 305.

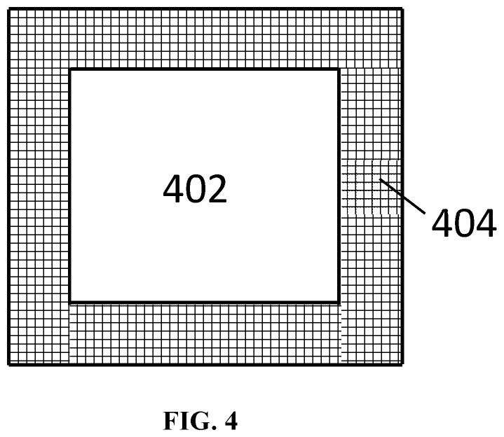

FIG. 4 is not drawn to scale. FIG. 4 shows a top schematic of a bilayer of a portion of an electrochemical stack, wherein the second layer of a metal sheet 404 is in the shape of a rectangular perimeter and has been placed on top of a bilayer, wherein at least a portion of lithium-stuffed garnet-metal film 402 is in contact with the second layer of a metal sheet 404.

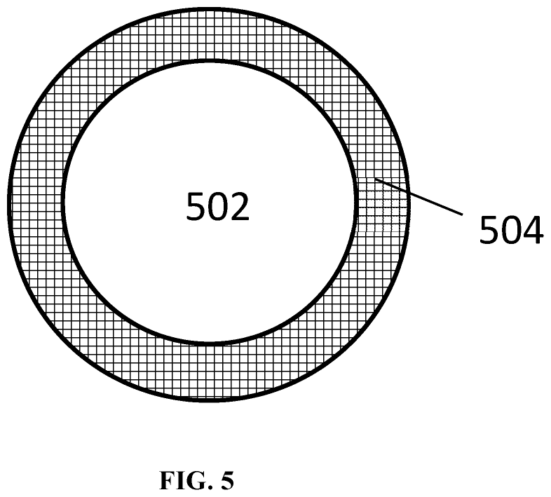

FIG. 5 is not drawn to scale. FIG. 5 shows a top schematic of a bilayer of a portion of an electrochemical stack, wherein the second layer of a metal sheet 504 is in the shape of a circular perimeter and has been placed on top of a bilayer, wherein at least a portion of lithium-stuffed garnet-metal film 502 is in contact with the second layer of a metal sheet 504.

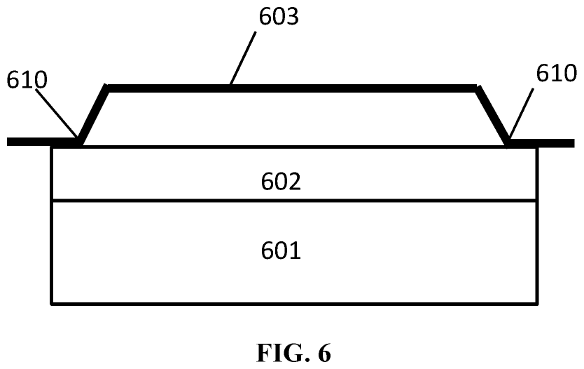

FIG. 6 is not drawn to scale. FIG. 6 shows a cross-sectional schematic of a portion of an electrochemical cell. In this embodiment, the portion of the electrochemical cell is discharged. The lithium-stuffed garnet-metal film 602 is adjacent to the lithium-stuffed garnet 601. A first metal layer 603 is attached to a portion of the lithium-stuffed garnet-metal film 602 at points 610. In some embodiments, a first metal layer 603 is attached to a portion of the lithium-stuffed garnet-metal film using an adhesive. An adhesive may be a glue, an epoxy, a resin, a polyester, a polyurethane, or silicon based material. In some cases, the attachment of first metal layer 603 to lithium-stuffed garnet-metal film 602 may be the result of heating or melting first metal layer 603, thus forming a bond or connection point to lithium-stuffed garnet-metal film 602. In some cases, as shown in FIG. 6, there may be a gap between lithium-stuffed garnet-metal film 602 and first metal layer 603. The gap may be filled with atmospheric gas. In some cases, the gap may be filled with inert gas, such as nitrogen or argon.

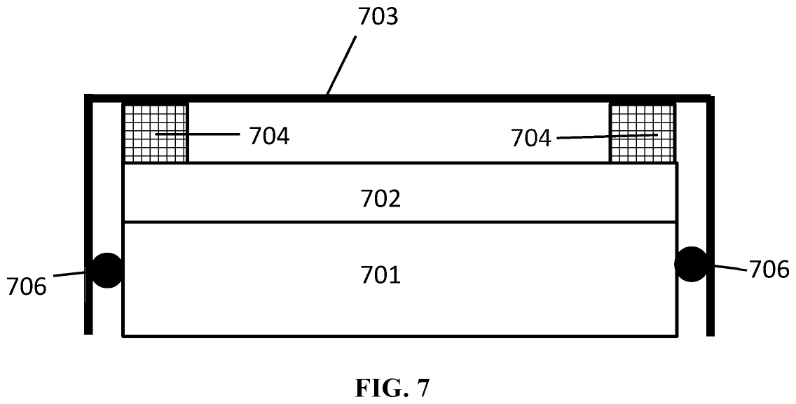

FIG. 7 is not drawn to scale. FIG. 7 shows a cross-sectional schematic of a portion of an electrochemical cell. In this embodiment, the portion of the electrochemical cell is discharged. Lithium-stuffed garnet film 701 is adjacent to lithium-stuffed garnet-metal film 702. Together, lithium-stuffed garnet film 701 and lithium-stuffed garnet-metal film 702 form a bilayer of an electrochemical cell. A metal sheet comprises a first metal layer 703 and a second metal layer 704. As illustrated in FIG. 7, a portion of the second metal layer 704 of the metal sheet is adjacent to the lithium-stuffed garnet-metal film 702. As illustrated in FIG. 7, a portion of the first metal layer 703 is adjacent to metal 706, wherein metal 706 is adjacent to lithium-stuffed garnet film 701.

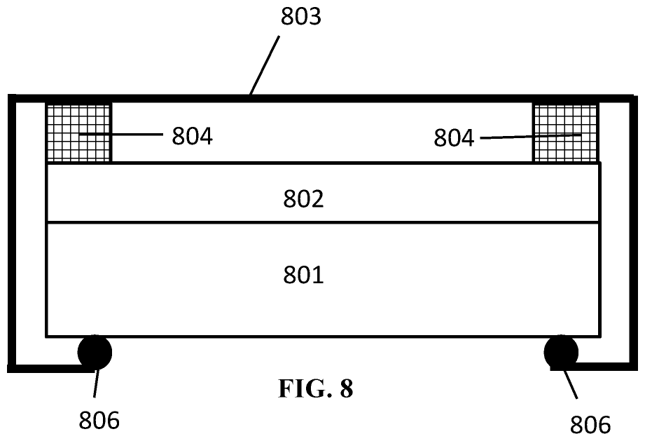

FIG. 8 is not drawn to scale. FIG. 8 shows a cross-sectional schematic of a portion of an electrochemical cell. In this embodiment, the portion of the electrochemical cell is discharged. Lithium-stuffed garnet film 801 is adjacent to lithium-stuffed garnet-metal film 802. Together, lithium-stuffed garnet film 801 and lithium-stuffed garnet-metal film 802 form a bilayer of an electrochemical cell. A metal sheet comprises a first metal layer 803 and a second metal layer 804. As illustrated in FIG. 8, a portion of the second metal layer 804 of the metal sheet is adjacent to the lithium-stuffed garnet-metal film 802. As illustrated in FIG. 8, a portion of the first metal layer 803 is adjacent to metal 806, wherein metal 806 is adjacent to lithium-stuffed garnet film 801.

### VII. METHODS OF MAKING

In some embodiments, the present disclosure provides a method of making an electrochemical stack comprising: providing a bilayer, wherein the bilayer comprises a lithium-stuffed garnet film and a lithium-stuffed garnet-metal film; applying a metal sheet to the bilayer, wherein the metal sheet comprises a first metal layer and a second metal layer.

In some embodiments, the present disclosure provides a method of making an electrochemical stack comprising: providing a bilayer, wherein the bilayer comprises a lithium-stuffed garnet film and a ceramic-metal film; applying a metal sheet to the bilayer, wherein the metal sheet comprises a first metal layer and a second metal layer.

In some examples, including any of the foregoing, applying a metal sheet to said bilayer includes contacting at least a part of a metal sheet to a part of a bilayer. The metal sheet may contact the bilayer by placement of one part onto the other, with or without pressure, and with or without heat.

In some embodiments, the metal sheet or a portion thereof may be commercially purchased. In some embodiments, the metal sheet or a portion thereof may be made individually and subsequently bonded together to form a single metal sheet unit.

In some embodiments, a metal sheet may be joined together by solder or soldering techniques, such as, for example, silver soldering, induction soldering, fiber focus infrared soldering, pipe soldering, mechanical or aluminum soldering, resistance soldering, or using ultrasonic vibrations to solder. In some embodiments, a metal sheet may be produced by a method such as brazing. Brazing can be torch brazing, active metal brazing, aluminum vacuum brazing, brazing under controlled atmosphere, honeycomb brazing, continuous/mesh belt brazing, reducing atmosphere brazing, repair/restorative brazing, vacuum brazing, hydrogen brazing, hip diffusion bonding, electron beam welding, induction brazing, or furnace brazing. In some embodiments, a metal sheet may be welded together.

In some embodiments, a metal layer is welded by a laser or melted or heated onto the bilayer. In some embodiments, application of a metal sheet may be after assembly of an electrochemical stack. In some embodiments, application of a metal sheet may be before assembly of an electrochemical stack.

In some embodiments, an electrochemical stack may be formed under atmospheric conditions. In some cases, certain procedures of formation of an electrochemical stack may be under inert gas, such as nitrogen or argon. In some cases, certain procedures of formation of an electrochemical stack may be under vacuum, wherein the pressure is less than about 760 Torr, 600 Torr, 500 Torr, 400 Torr, 300 Torr, 200 Torr, 100 Torr, 50 Torr or less.

In some examples, the methods include heating the electrochemical stack to at least about 40° C., 50° C., 60° C., 70° C., 80° C., 90° C., 100° C., or higher. In some embodiments, formation of an electrochemical stack occurs at temperatures of 500° C., 400° C., 300° C., 200° C., or lower.

### VIII. EXAMPLES

Reagents, chemicals, and materials disclosed herein were commercially purchased unless stated otherwise.

The electrochemical potentiostat used was an Arbin potentiostat. Electrical impedance spectroscopy (EIS) was performed with a Biologic VMP3, VSP, VSP-300, SP-150, or SP-200.

### Example 1

### Making an Electrochemical Cell Having a Metal Sheet and a Bilayer

A series of electrochemical cells were prepared as follows.

A bilayer comprising two layers was prepared.

The first layer was made of a lithium-stuffed garnet-metal film. The lithium-stuffed garnet-metal film was made by co-sintering calcined lithium-stuffed garnet powder with nickel (Ni) metal powder. First, a slurry was prepared. This slurry was made by milling lithium-stuffed garnet powder in dimethyl ether (DME) with a dispersant. The DME solvent was replaced with terpineol using centrifugation techniques. The resulting slurry of lithium-stuffed garnet powder and terpineol was moved to a dry room. Nickel powder and a binder solution (binder and plasticizer in terpineol) were added to the slurry and the slurry was mixed using a FlackTek speed mixer.

The resulting slurry was then tape cast as follows. A semi-automatic DEK screen printer was used for tape-casting green tape. A 400 mesh screen was loaded into the printer and Ni ink was deposited onto the screen. A sheet of green tape was loaded onto the screen printer's vacuum chuck which was moved into the print position. The green tape was then screen printed, and then was removed from the printer. The printed green tape was placed into a desiccator for temporary storage. The prints were then batch dried in a convection oven and packed.

The resulting green prints were then sintered as follows. Sintering setters were cleaned. Printed green tape was cleaned and peeled using a vacuum peeler and then cut into the appropriate size using an automated blade or the laser cutter. The green tape as positioned between sintering setters and sintered above 800° C. for two days.

The second layer was made of a lithium-stuffed garnet film. The lithium-stuffed garnet film was made according to the Example 11 of U.S. Pat. No. 10,403,932 B2, the entire contents of which are herein incorporated by reference in its entirety for all purposes.

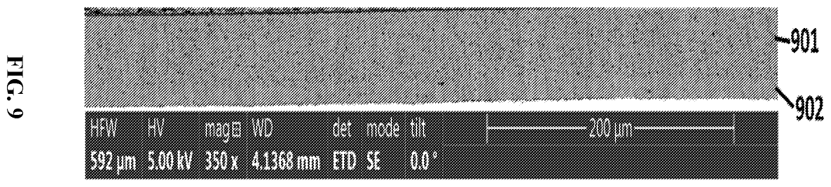

The first layer and second layer were laminated together by placing one on top of the other and sintering the two layers together in an oven. An example bilayer is shown in FIG. 9. As shown in FIG. 9, layer 901 is the lithium-stuffed garnet film and layer 902 is the lithium-stuffed garnet-metal film with an adjacent anode current collector layer. The scale bar in FIG. 9 is 200 μm.

The sintered bilayer that resulted was placed on a fixturing clamp, with the lithium-stuffed garnet film on the bottom. The bilayer was fixed to a metal ring using one of two methods:

Methods 1. A flux-coated metal ring was placed over the film as a preform so that the metal ring was adjacent to the lithium-stuffed garnet-metal film. A nickel foil was placed over the preform so that the nickel foil entirely overlapped the metal ring. A thin piece of silicon rubber was placed over the nickel foil. The entire assembly was clamped with force, around 500 Torr. The assembly was loaded into a vacuum reflow oven. The vacuum was turned on. The assembly was radiatively heated above the melting temperature of the metal ring, about 200° C. The assembly was kept at 200° C. for about 2 hours. The assembly was then cooled to about 100° C. A reflow oven was then repressurize with argon gas, then cooled to room temperature of 25° C. The clamp was removed, releasing the bilayer and metal sheet adhered to the bilayer.

Method 2. The bilayer is placed on a fixturing clamp, with the lithium-stuffed garnet film on the bottom. A metal perimeter in the shape of a rectangle is placed over the film so that the metal perimeter is adjacent to and directly contacts the lithium-stuffed garnet-metal film. A rectangular nickel foil is placed over the preform so that the nickel foil entirely overlaps the metal ring. A piece of silicon rubber is placed over the nickel foil. The entire assembly is clamped with force, around 2000 Torr. The assembly is loaded into a vacuum reflow over. The vacuum is turned on. The assembly is radiatively heated above the melting temperature of the metal ring, about 190° C. The assembly is kept at 190° C. for about 1 hour. The assembly is then cooled to about 150° C. The reflow oven is then re-pressurized with nitrogen gas, then cooled to room temperature of 25° C. The clamp is removed, releasing the bilayer and metal sheet adhered to the bilayer. The assembly is then built into a full cell.

The bilayer assemblies made above were then built into full cells, each in a pouch cell with NMC at loading 4.6 mAh/cm².

### Example 3

### Testing an Electrochemical Cell

The series of electrochemical cells from Examples 1 and 2 were tested. Cycling of the full cells included (LLZO separator, Ni+LLZO negative current collector, no excess Li) 1C charge and 1C discharge at 30° C. Cells were cycled between 3-4.2V.

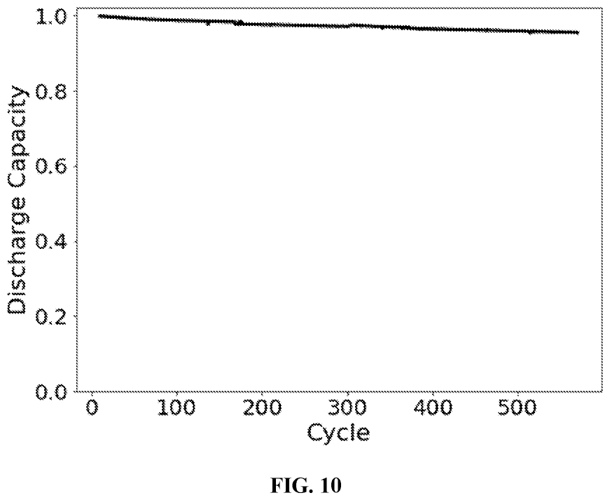

The results are shown in FIG. 10.

The cells were analyzed using electrical impedance spectroscopy (EIS). The cells with a bilayer and metal sheet are shown to have a lower increase in area-specific resistance (ASR) over the first ten cycles when compared to cells that have no metal sheet.

The samples with a seal had an average of 10% increase in resistance, while the samples without a seal had an average of nearly 40% increase in resistance; a statistical comparison of samples in this test show highly significant results (p=0.0014).

The embodiments and examples described above are intended to be merely illustrative and non-limiting. Those skilled in the art will recognize or will be able to ascertain using no more than routine experimentation, numerous equivalents of specific compounds, materials and procedures. All such equivalents are considered to be within the scope and are encompassed by the appended claims.

1. An electrochemical stack comprising a bilayer and a metal sheet:
wherein said bilayer comprises a lithium-stuffed garnet film and a lithium-stuffed garnet-metal film; and
wherein said metal sheet comprises a first metal layer and a second metal layer, wherein at least a portion of said bilayer is adjacent to said metal sheet.

2. The electrochemical stack of claim 1, wherein said lithium-stuffed garnet-metal film contains a first area and a second area, wherein said first area and said second area comprise a similar composition.

3. The electrochemical stack of any one of claim 1, wherein said lithium-stuffed garnet-metal film contains a first area and a second area, wherein said first area and said second area comprise different compositions.

4. The electrochemical stack of claim 2, wherein said first area of said lithium-stuffed garnet-metal film comprises a first metal powder and lithium-stuffed garnet powder.

5. The electrochemical stack of claim 4, wherein said first area of said lithium-stuffed garnet-metal film comprises at least about 50% by molar ratio of said first metal powder and at least about 20% by molar ratio of said lithium-stuffed garnet powder.

6. The electrochemical stack of claim 2, wherein said second area of said lithium-stuffed garnet-metal film comprises at least about 50% by molar ratio of a second metal powder.

7. The electrochemical stack of claim 4, wherein said first metal powder comprises Ni, Cu, Al, iron, titanium, steel, alloys, or combinations thereof.

8. The electrochemical stack of claim 6, wherein said second metal powder comprises Ni, Cu, Al, iron, titanium, steel, alloys, or combinations thereof.

9. The electrochemical stack of claim 1, wherein at least a portion of said lithium-stuffed garnet-metal film is adjacent to at least a portion of said second metal layer.

10. The electrochemical stack of claim 1, wherein at least 5% by surface area of lithium-stuffed garnet-metal film is adjacent to at least a portion of said second metal layer.

11. The electrochemical stack of claim 1, wherein the perimeter of said metal sheet is adjacent to less than about 99% by surface area of said lithium-stuffed garnet-metal film.

12. The electrochemical stack of claim 1, wherein the perimeter of said metal sheet is adjacent to less than about 50% by surface area of said lithium-stuffed garnet-metal film.

13. The electrochemical stack of claim 1, wherein the perimeter of said metal sheet comprises Ni, Cu, Al, steel, alloys, or combinations thereof.

14. The electrochemical stack of claim 1, wherein the perimeter of said metal sheet has a melting temperature of less than about 800° C.

15.-32. (canceled)

33. A method of making an electrochemical stack comprising:
applying a metal sheet to a bilayer,
wherein said bilayer comprises a lithium-stuffed garnet film and a lithium-stuffed garnet-metal film;
wherein said metal sheet comprises a first metal layer and a second metal layer.

34.-35. (canceled)

36. An electrochemical stack comprising:
a layer comprising lithium-stuffed garnet;
a layer comprising a ceramic and a metal; and
a metal sheet; wherein
the layer comprising a ceramic and a metal is between and in contact with the layer comprising lithium-stuffed garnet and the metal sheet.

37. The electrochemical stack of claim 36, wherein the metal sheet comprises a first portion and a second portion, wherein the metal sheet is adjacent to the layer comprising ceramic and a metal.

38. The electrochemical stack of claim 36, wherein the layer comprising a ceramic and a metal is a layer in which the ceramic and the metal were sintered together.

39. The electrochemical stack of claim 38, wherein the layer comprising a ceramic and a metal is a layer in which the ceramic and the metal were sintered together as power ceramic and powder metal.

40. The electrochemical stack of claim 36, wherein when the stack is completely discharged, the electrochemical stack comprises a bilayer which comprises the layer comprising a lithium-stuffed garnet and the layer comprising a ceramic and a metal.

41.-55. (canceled)
